(19) United States
(12) Patent Application Publication
(10) Pub. No.: US 2011/0035594 A1
(43) Pub. Date: Feb. 10, 2011

(54) Apparatus and method for providing elective message tagging

(76) Inventor: Barbara Ann Fox, Palm Beach Gardens, FL (US)

Correspondence Address: Barbara Ann Fox, 394 Isle Court, Palm Beach Gardens, FL, 33418, US

(21) Appl. No.: 12/804,465

(22) Filed: Jul. 22, 2010

Related U.S. Application Data
(60) Provisional application No. 61/271,859, filed on Jul. 27, 2009.

(51) Int. Cl. H04L 9/32; G06F 15/173; G06F 15/16; G06F 21/00

(52) U.S. Cl. 713/170; 709/206; 726/4

(57) ABSTRACT

A computer-implemented apparatus and method for providing elective message tagging related services, comprising: receiving a request to receive, processing information regarding the request; and transmitting in response to the request, an elective message tag in conjunction with a second communication, wherein the elective message tag consists of any one or more of data, information, advertisements, offers, solicitations, promotions, confirmations, tickets, receipts, content, digital content, activations, authorizations, authentications, hyper-links, programs, applications, code, scripts, files, video, audio, images, avatars, pixel tags, clear gifs, web beacons, voice, text, signals, warnings, prompts, requests, restrictions, limitations, monitoring functions, management operations, rules, policies, practices, aggregated information, implementations, dissolutions, disallowances, messages, notifications, controls, communications, and/or an embodiment of information, and/or an embodiment of control functionality.

### FIELD OF THE INVENTION

The present invention pertains to an apparatus and method for providing elective message tagging, and in particular, the present invention pertains to an apparatus and method for elective message tagging, which provides enhanced products and/or services for engineering, communications, entertainment, and other industries and individuals who or which utilize same.

### BACKGROUND OF THE INVENTION

The addition of tags to assist in the identification or conveyance of information is one of the more fundamental challenges facing engineers, communications professionals, and marketers when seeking to manage, regulate, guide, inform, offer, and direct users, senders, and recipients of messages. As an example, such tags might be technical in nature so as to assist in the delivery of the message, or they might contain metadata which provides a context to the message recipient, or they might be an addendum with supplementary information for the recipient. With ever increasingly complex engineering, communications, and marketing endeavors undertaken, there is a continual increase the importance of and challenge associated with efficient and effective tagging.

To illustrate the point, some tags might be communications protocols included with the data packets containing the content sent over communications networks, or they may also be a bordering image to photograph identifying the publisher, or they may be a hyper-link attached to a message enabling the recipient to access their account.

The ability to effectively associate and efficiently pair a tag to a message can lead to the development of products and services in the United States and throughout the rest of the world that would benefit industry and individuals. Throughout past decades, innovations in tagging technologies have enabled the founding and growth of industries and improved lives of individuals due to the ability to improve the management, regulation, guidance, information, and offers associated with messages, while mitigating the unnecessary, wasteful, unwanted, malicious, or detrimental conveyance of misdirected, and/or malevolent messages.

In spite of the fact that tagging has for decades been a challenge for engineers, communications professionals, and marketers, current message tagging systems have many shortcomings in an age when engineers, communications professionals, and marketers demand innovative, effective, commercially viable mechanisms to be more efficient and effective.

Typically, engineers, communications professionals, and marketers have to rely on a limited scope of supply side paradigms for nearly every application for which a message tagging is needed. Today, this often this results in control disequilibrium between providers of messaging technologies and related services, the transmitters of messages, and the recipients of such messages. For example, today's builders and operators of communications networks, cloud based computing applications, messaging services, and related platforms view tagging as having an essential security, management, and commercial function. Yet, the ability to apply an elective, versatile, controllable, customizable, and a readily available tagging system for use by the message recipient would make the benefits of tagging more widely available to marketers and builders of engineered systems, devices, products, and services. The result being that many more people would benefit from improved safety, management, and performance of these systems, devices, products, and services.

The inefficiencies associated with the current systems for providing tagging systems to systems, devices, products, and services may be characterized by the imbalance between the supply side of the messaging and tagging platform, including control over content and delivery parameters, and with the demand side of the message and associated tagging. This imbalance of control between the supply and demand sides severely limits efficiency and effectiveness of tagging solutions. Precisely, the tagging systems employed today are created and controlled on the supply side and the delivery side of the message as opposed to the demand side and/or receiver and/or subscriber side of the message. Supply side optimization techniques for messaging tagging, such as profiling of user data, are considered invasive and raise serious security and data privacy concerns with users and government regulators. By enabling an apparatus and method of controllable receiver and/or subscriber sided tagging that can be readily implemented across a plethora of communications, computing, and engineering applications will enable the benefits of tagging to be achieved by many more individuals in the systems, devices, and products they use, while assuring a significantly higher degree of security and data privacy. The net benefit would accrue in terms of safety, security, privacy, performance, cost, and time.

### SUMMARY OF THE INVENTION

The present invention pertains to an apparatus and method for providing elective message tagging, and in particular, the present invention pertains to an apparatus and method for elective message tagging, which provides enhanced products and/or services for engineering, communications, entertainment, and other industries and individuals who or which utilize same.

The present invention provides an apparatus and method of use by which message tagging can be effectuated created and controlled on the demand side and/or receiver and/or subscriber side of the message. The present invention with receiver and/or subscriber sided controlled tagging, also described as elective message tagging, which can be readily implemented across a plethora of applications, computing environments, communications solutions will enable the benefits of tagging to be achieved by many more individuals in the systems, devices, and products they use.

The apparatus and method of the present invention is intended to perform as an elective message tagging apparatus and method so as to create a demand side, receiver and/or subscriber controlled tagging of any message to which the message tagging may be fixed and/or associated, with the resulting effect being demand side controlled tagging and/or receiver and/or subscriber side controlled tagging.

The apparatus and method of the present invention is to be utilized to provide a comprehensive elective message tagging platform for the very many types of engineering, communications, entertainment and other commercial products, services, communications and computing platforms.

The apparatus and method of the present invention is to be utilized to provide a comprehensive message tagging platform and/or service by which individuals, subscribers, registrants, and/or agents thereof may elect to, and register for receiving and/or sending messages with information, data, communications, and offers, wherein the elected message is tagged onto, embedded in, and/or otherwise associated with another in-bound and/or out-bound message that may be affiliated with the elected tagged message, and/or driven by a set of rules and/or artificial intelligence, and/or intelligent agents which may be under the direction, control, and/or influence of the electing receiver and/or subscriber, electing sender, and/or communications account holder, and/or are affiliated with the elected tagged message itself.

The apparatus and method of the present invention is to be utilized in such types of engineering, communicatory, entertainment, public service, and/or other commercial products, services, and platforms may include, but are not limited to, data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, and/or an embodiment of information, and/or an embodiment of control functionality.

The apparatus and method of the present invention may be utilized in such types of engineering, communicatory, entertainment, public service, and/or other commercial services, products, and/or platforms, using technologies of the following nature: digital and/or electronic and/or audio and/or video and/or voice and/or tactile and/or image and/or gestation and/or olfacaction and/or equilibrioception and/or thermoception and/or proprioception and/or nociception and/or interoception and/or echolocation and/or electroception and/or magnetoception and/or pressure detection and/or current detection and/or polarized light direction detection and/or slit sensillae and/or vibratory and/or radiation and/or energy waves and/or particles.

The apparatus and method of the present invention enables various types of engineering, communicatory, entertainment, and other commercial products, services to occur in a multitude of temporal contexts that include, but are not limited to, pre-communication and/or transaction, during communication and/or transaction, real-time communication and/or transaction, and post-communication and/or transaction.

The apparatus and method of the present invention, may be utilized in conjunction with, on, or over, a plurality of communications and/or computing networks, and/or systems, which may include, but are not limited to, any one or any combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, geo synchronous satellite systems, as well as in, or on any internets and/or intranets, computing networks, cloud computing systems, servers, client devices, client-server architectures, quantum computers, quantum storage, communications networks, terrestrial networks, undersea networks, mobile networks, satellite networks, mesh networks, the Internet, World Wide Web, WWW2, WWW3, Semantic Web, closed circuit networks, open networks, radio networks, optical networks, pulse networks, digital networks, wave networks, light networks, neural networks, chemical networks, materials networks, biological networks, radiation networks, energy wave networks, and/or particle based networks, and/or where it may occur in a supra-global network environment, global network environment, trans-national network environment, national network environment, wide area network environment, metropolitan area network environment, local area network environment, personal network area environment, inter-being network environment, intra-being network environment, human-to-machine network environment, machine-to-machine network environment, and/or human-to-non-human network environment, and any other suitable communication network or system.

The apparatus and method of the present invention, including its data, information, content and the like, can exist in various lengths, sizes, complexities, series, and/or in conjunction with series of communications, conversations, repeated communications, one-way communications, two-way communications, multi-party communications, machine communications, machine-to-human communications, machine-to-machine, multi-party machine communications, peer-to-peer communications, simplex communications, duplex communications, two-way duplex communications, and/or support systems and/or network configurations in order to enable a multitude of demand side, receiver and/or subscriber controlled message tagging. Moreover, the format and/or encoding used in the creation, dissemination, transmission, transfer, and/or reception of such tagging may vary, and/or be in one or more forms and/or be in multiple-forms at a single instance, in order to ensure that a certain type of message tagging is effectuated for a particular purpose.

The apparatus and method of the present invention can be controlled, managed, monitored, in any combination of a network, client, server, communications tool, computing mechanism, and/or device, in such a way that the elective message tagging of messages is effectuated.

The apparatus and method of the present invention can provide notifications to parties to the elective messaging relationship regarding all aspects of a commercial and/or technical nature of any one or more stages including offering, counter-offering, acceptance, establishment, set-up, execution, management, status, dissolution, and/or confirmation of the messaging tagging relationship.

The apparatus and method of the present invention can exist in various scaling configurations in order to enable a multitude of uses. By example, the device may be constructed to operate in a one-to-one, one-to-few, one-to-many, many-to-one, many-to-few, many-to-many, few-to-one, few-to-few, few-to-many, wherein a single user can be a subset of a broader entity, and/or where multiple users can be massively multi-user in nature, and/or for a single entity acting as either and/or both the sender and receiver and/or subscriber of the message and the associated tagging. Or, it may be the case that the apparatus and/or method are two entities with one or both acting as either and/or both the senders and/or receivers of the message and the associated tagging. Or, it may be the case that the apparatus and method are multiple greater than two entities, any one, several, or all may be acting as either and/or both the senders and/or receivers of the message and the associated tagging.

The apparatus and method of the present invention can be constructed with varying volumes of messaging and associated tagging in any one transmission, series of transmissions, parallel transmissions, identical transmissions, customized transmissions, and/or unique transmissions. Or, it may be the case that the apparatus and method are configured in a manner that permits reactive, proactive, or dynamic changes to its volumes of messaging and associated tagging parameters.

The apparatus and method of the present invention can be constructed with various technologies, algorithms, intelligent agents, code, instruction sets, and/or control functionalities, both statically and/or dynamically configurable, in order to effectuate a multitude of message tagging effects, such as but not limited to its message tagging effects in response to any one or any combination of varying criteria or parameters identified by the demand side, and/or receiver and/or subscriber side of the messaging and the associated messaging tagging, which may include but is not limited to status or changes associated with systems, networks, accounts, contexts, demographics, politics, economics, individual status, sociological, demographical, geological, environmental, psychological, physiological, medical, systems, security, and/or financial criteria.

The present invention may be constructed as an apparatus and/or method to automatically generate, and/or configure, and/or transmit, and/or receive a single message and associated elective message tagging or multitude of messages and associated elective message tagging effects, such as but not limited to its message tagging effects in response to any one or any combination of varying criteria or parameters identified by the demand side, and/or receiver and/or subscriber side of the messaging and the associated messaging tagging, which may include but is not limited to status or changes in status or in response to changes associated with systems, network, account, demographic, political, economic, contextual, individual, sociological, geographical, geological, environmental, psychological, physiological, medical, systems, security, economic, and/or financial criteria.

The apparatus and method of the present invention can be constructed to enable multiple elective message tagging functions acting either in concert and/or independently in order to effectuate a multitude of message tagging effects, such as but not limited to its message tagging effects in defined groups, random samplings, algorithmically defined sets, contextual circumstances, geographic, and/or demographic segments.

The apparatus and method of the present invention can be constructed to enable the storing of data related to the processing, fulfillment, and management of elective message tagging services based upon data and/or information regarding the elective message tagging subscriber, including all histories of usage, commercial terms, payments, technical, and/or communications usage in conjunction with the elective messaging tagging service. This may include, but is not limited to, data and/or information regarding the subscriber including all communications account information, financial account information, and a multitude of profiling information including, but not limited to, preferences, demographics, activity streams, behavioral targeting, data logging, digital footprint, lifelog, lifestreaming, profiling, runtime intelligence, social translucence, trace, trace evidence, genetic sequencing, psychographics, data represented in Attention Profiling Mark-up Language, subject and/or interest item information, communications, browsing histories, browsing patterns, documents, files, computational usage statistics, communications usage statistics, content created, content viewed, heard and/or read, content downloaded, applications used and/or downloaded, search queries, search results, click-through on search results, digital traces, activities, behaviors, login and logouts, visit of pages, documents accesses, items created, affiliation to groups, attention, social group, repetition, location, reputation, financial activities, investing activities, income data, spending data, consumption data, tax data, credit data, credit history data, reputational data, media related data, sensor discovered data, sensor recorded data, digital footprints, digital finger prints, life streams, social media linkages, social media activities, communications activities, computing activities, personal status, medical information, health information, personally identifiable information, volunteered information, collected information, rumored information, non-volunteered information, information capable of being stored in log files, information capable of being stored locally and/or or in a private and/or public cloud computing environment, information capable of being stored in databases, mined data, as well as the analytics associated with the aforementioned data and/or information, with respect to the services provided related to elective message tagging.

The apparatus and method of the present invention can be constructed to enable the storing of data related to the processing, fulfillment, and management of elective message tagging services based upon data and/or information regarding the services provided by the elective message tagging service provider, and/or affiliated service providers, including services previously offered, currently offered, and/or prospectively offered, content, communications, and/or commercial information regarding message tags including, but not limited to, data received by and/or from the elective message tag subscriber, data received by and/or from the elective message tag provider, and/or data generated by the elective message tag service provider through activities associated with the providing of elective message tagging services, as well as the analytics associated with any of the aforementioned data and/or information, with respect to the services provided related to elective message tagging.

The apparatus and method of the present invention can be constructed to enable the storing of data related to the processing, fulfillment, and management of elective message tagging services based upon data and/or information regarding the actual tag tags provided and/or offered by the elective message tag providers, including, but not limited to data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, and/or an embodiment of information, and/or an embodiment of control functionality, with respect to the services provided related to elective message tagging.

The apparatus and method of the present invention includes a computer-implemented system for the registration and/or subscription processing of registrations and/or subscriptions and/or requests concerning registrations and/or subscriptions, wherein the computer-implemented system establishes registrations and/or subscriptions and/or accounts associated with registrations and/or subscriptions on behalf of registrants and/or subscribers to any of the respective elective message tagging services described herein. The registration and/or subscription may be both static and persistent, such as lasting beyond the operation of a pre-defined tagging action, or dynamic and temporary which ceases to exist after completing its pre-defined tagging action. Further processing functions can include the assessment of the request to establish an account, a subscription, and/or a commercial relationship made by the requestor, the collection of communication account information, financial account information, other personal identifiable information, credit information, personal financial information, demographic information, security information, information necessary to establish a legitimate commercial relationship between the requestor of the elective message tagging service, the provider of the message tag and/or tags, and the elective message tag service provider, as well as confirmations, consent, permissions, and links to third-party entities which may be required to establish the commercial and/or technical relationships needed to establish the commercial and technical functionality requested and agreed to by the elective message tag requestor, the message tag provider, and the elective message tag service provider.

The apparatus and method of the present invention includes a computer-implemented system for the registration and/or subscription fulfillment of registrations and/or subscriptions pursuant to the outcome of the processing function of the request for registration and/or subscription, wherein the computer-implemented system fulfills agreed commercial and technical actions pursuant to the information and agreements of the processing function on behalf of registrants and/or subscribers to any of the respective elective message tagging services described herein and/or to the providers of the message tags described herein. Further fulfillment functions can include an assessment of inventory of message tags that would meet the parameters of the requestor, an assessment of inventory of message tags that would meet the parameters of the message tag provider, a proposal for pairing the commercial and/or technical interests of the requestor, the message tag provider, and the elective message tag service provider.

The apparatus and method of the present invention includes a computer-implemented system for the registration and/or subscription management of registrations and/or subscriptions pursuant to the outcome of the processing function of the request for registration and/or subscription, wherein the computer-implemented system manages the various commercial, technical, and operational aspects of the relationship established between the requestor of the elective message tagging service, the provider of the message tag and/or tags, and the elective message tag service provider. Such management capabilities can include, but are not limited to, systems inventory, systems service inventory, systems component inventory, installation management, service and systems availability monitoring and metrics, user activities monitoring and logging, capacity monitoring, security management, storage management, network capacity and utilization monitoring, fault management, troubleshooting, error logging and data recovery, configuration management, automatic updates, upgrades, repairs, system complexity assessments, system risk assessments, energy use, system reuse capabilities, licensing, license management, rights management, digital rights management, rights acquisition, rights payments, rights accounting, provisioning, forecasting, needs assessment, modeling, training, deployment, dependencies assessment, automation, accounting management, billing, statistics, performance management, usage metering, user monitoring, user accounting, user authentication, user authorization, use rights, tracking usage, assessing usage to rights, application of analysis to metrics, recommendations, application of algorithms, control, monitoring, limiting, application of intelligent agents, parameter setting, restriction, prevention, event monitoring, metric monitoring, reliability assessment, error tracking, software bug detection, software bug repair, trend assessment, failure assessment, life expectancy analysis, security management, identity management, policy management, business impact functions, business systems management, capacity management, real-time application relationship discovery, configuration management, security information, event management, workload scheduling, performance management, end-to-end performance measuring, infrastructure component measuring, operational intelligence, real-time monitoring of non-systems events that relate to systems processes, business activity monitoring, business transaction management, registration, fulfillment of secondary and/or derivative commercial orders and/or commercial service requests and/or purchase made in conjunction with and/or as a result of the herein described elective message tagging services, as well as subscriptions, subscribing, further fulfillment of additional registration and/or subscription requests for elective message tagging services and/or out-bound elective message tagging services, communications, data, and/or any other digital content and/or link to data or content and/or any other good and/or services provided pursuant to a relationship, contractual and/or otherwise, which provides for a regular transaction between the parties and/or facilitated by an intermediary.

The apparatus and method of the present invention can be utilized for disseminating digital content and/or information to a subscriber and/or registrant of any digital product and service which can be provided in commerce.

The computer-implemented subscription and/or registration processing system, the computer-implemented subscription and/or registration fulfillment system, and the computer-implemented subscription and/or registration management system, are all systems that may exist in a multitude of hardware, software, and network configurations, wherein all and/or some components may be located in or at the same location, remote locations, in a network, on a server, on a client device, or in some combination of the above. Increasingly as more communications functionality is able to be performed by software, and increasingly communications and computing systems resources can be partitioned and used to execute functions which would have in the past required distinct systems, any and all of the functions described as being unique to either the computer-implemented subscription and/or registration processing system, the computer-implemented subscription and/or registration fulfillment system, and the computer-implemented subscription and/or registration management system can also be seen as functions occurring in a single computer-implemented system.

The apparatus and method of the present invention also includes at least one or more receiving devices which function as a first receiving device to receive the request for elective message tags described herein. This receiving device may be a single or multiple device configurations working in conjunction with the computer-implemented system for inbound message tagging subscription/request processing, fulfillment, and management which serves to receive information from the individual making the request of the elective message tagging service.

The apparatus and method of the present invention also includes at least one or more receiving devices which serve as the second receiving device to receive the actual message tag and/or tags described herein. The receiving device and the aforementioned communication device may be the same device or different devices as is designated by the individual making the request of the elective message. By example, the first device may be a smartphone wherein the request to receive an elective message tag is sent by the individual making the request of the elective message tagging service, who is also the account holder of the smart phone, and this same smartphone may in-fact be the same device that is then registered to be the receiving device for the elective message tag.

The apparatus and method of the present invention also includes at least one or more transmitting devices which function as a first transmitting device to enable the sending of the response to the request for elective message tags described herein. This transmitting device may be a single or multiple device configurations working in conjunction with the computer-implemented system which serves to transmit information to the individual making the request of the elective message tagging service.

The apparatus and method of the present invention also includes at least one or more transmitting devices which serve as the second transmitting device to transmit the commercial and/or technical information regarding the registration and/or account related to the elective message tagging service described herein. The transmitting device and the aforementioned communication device may be the same device or different devices as is designated by the individual making the transmission of the service request associated with the elective message tagging service. The transmitting and receiving device may be the same or separate devices. By example, the first receiving device may be a personal computer wherein the request to receive an elective message tag is sent by the individual making the request of the elective message tagging service, who is also the account holder of an email account accessed by that personal computer, while at the same time the individual user may make a request to have the elective message tag sent both to the said email account and also a voicemail account associated with a mobile phone.

Concerning the apparatus and method of the present invention, collectively speaking, the first transceiver and first receiver of the elective message tagging system may be referred to as the first communications device, wherein the second transceiver and second receiver of the elective message tagging system may be referred to as the second communications device.

The apparatus and method of the present invention also includes a synching capability enabling the transmission of registration and/or subscription information regarding elective message tagging between user devices and accounts in instances where the elective message tagging subscriber and/or registrant has multiple devices and/or communications accounts to which they would like to have the elective message tagging functionality replicated. This synching capability can include the transmission of signals to/from devices and/or accounts under the direction of the elective messaging tagging subscriber, and receiving signals from a separate communication device and/or account. Such synching capabilities may occur in both a client-server-client and/or client-to-client manner wherein information regarding the inbound message service, related code, content, rights, and parameters of the commercial and technical capabilities are transmitted in a fashion as to enable the addition and/or removal of various receiving and/or transmitting devices controlled by the subscriber utilizing the elective message tagging service. In this manner, any of the parameters and/or instructions and/or communicated to the subscription and/or registration processing, fulfillment, and management computer-implemented systems, and/or the communication device, and/or receiver, and/or transmitter may communicate, update, and coordinate elective message tagging functions with each other.

A plurality of communication devices can be utilized in conjunction with the apparatus and method of the invention, with each device being utilized for similar and/or for separate functions related to elective message tagging, and may exist at the same or a multitude of locations. The elective message tagging system is designed to so as to serve a multitude of concurrent users and thus a plurality of communication devices can be utilized with each communication device being associated with a subscriber and/or registrant, and more than one communications device may be registered with each subscriber and/or registrant. The communication device can be a privately owned, leased rented, borrowed, or shared device, and may also be located at a public location and may be a public kiosk.

The elective message tagging computer-implemented systems described herein for subscription and/or registration processing, fulfillment, and management may be a single computer and/or computer system and/or may include a plurality of computers and/or computer systems. Similarly, any of the components of each of these systems may in itself be a single system and/or computer or set of multiple computers or computer-implemented systems.

The apparatus and method of the present invention may be utilized in conjunction with, on, or over, a plurality of communications and/or computing networks, and/or systems, which may include, but are not limited to, any one or any combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, geo synchronous satellite systems, as well as in, or on any internets and/or intranets, computing networks, cloud computing systems, servers, client devices, client-server architectures, quantum computers, quantum storage, communications networks, terrestrial networks, undersea networks, mobile networks, satellite networks, mesh networks, the Internet, World Wide Web, WWW2, WWW3, Semantic Web, closed circuit networks, open networks, radio networks, optical networks, pulse networks, digital networks, wave networks, light networks, neural networks, chemical networks, materials networks, biological networks, radiation networks, energy wave networks, and/or particle based networks, and/or where it may occur in a supra-global network environment, global network environment, trans-national network environment, national network environment, wide area network environment, metropolitan area network environment, local area network environment, personal network area environment, inter-being network environment, intra-being network environment, human-to-machine network environment, machine-to-machine network environment, and/or human-to-non-human network environment, and any other suitable communication network or system.

The apparatus and method of the present invention can also be utilized on, or over, any other suitable communication combination of communication and/or computing networks.

The apparatus and method of present invention can be utilized to request, process, provision, fulfill, and manage elective message tagging services, subscriptions and/or registrations. This functionality pertains to new, renewed, extended, terminated, and cancelled services, subscriptions and/or registrations.

The apparatus and method of the present invention can facilitate the provisioning, fulfillment, and/or management of services, and/or subscriptions and/or registrations related to elective message tagging in a network environment in a manner affording flexibility in the length and/or the duration of the service, subscription and/or registration.

The apparatus and method of the present invention can also provide a fulfillment clearinghouse function, wherein, the apparatus and method of the present invention can also provide notification to subscribers and/or other parties regarding elective message tagging offers, events, occurrences, promotions, happenings, discounting, incentives, and/or benefit regarding elective message tagging and/or services and/or products related to and/or derived from the service of and/or associated with providing elective message tagging services.

The apparatus and method of the present invention can be utilized in conjunction with subscriptions, and/or registrations involving digital communications, the transmission of data, information, digital content, and/or any other information, and/or digital entertainment content, and/or data, information, and/or content which can be transmitted over any of the herein described networks, and/or provisioned in conjunction with any of the herein described networks and delivered outside any of the herein described networks.

The messages described herein which are associated with elective message tagging may themselves be, or be associated with, or be of the nature of, messages in digital form or “e-messages”, and/or messages in any other form suited to carry an elective message tag, can be utilized in conjunction with any digital good and/or service which can be the subject of commerce, and can involve, but not be limited to, messages for and/or regarding offers to sell, offers to buy, offers to barter, offers to trade, solicitations, event tickets, digital content, digital information, physical goods, commercial goods, merchandise, industrial goods, consumer goods, digital services, physical services, commercial services, industrial services, movie rentals, video rentals, tickets, event tickets, program tickets, permissions, movie tickets, show tickets, airline tickets, bus tickets, gasoline purchases, postage stamps and/or postage, meals tickets, tickets to sporting events, tickets to entertainment events, tickets to theater performances, statements, reports, transaction reports, confirmations, status updates, communications, services, professional services, contracted for services, and/or any other good and/or service which can be the subject of commerce.

Any of the communications which occur and/or which transpire between any of the computers and/or devices, and/or which occurs between any elective message tag subscribers and/or registrants, and/or offering parties, and/or contracting parties, and/or messaging parties, and/or operators and/or administrators of any of the computers and/or devices, can be effectuated by or via electronic communications, digital communications, telecommunications, electronic mail (e-mail), electronic message transmission, short message service, electronic data transfer, electronic payment system, digital payment system, digital communications system, digital communications service, telephone message, voice mail message, pager message, beeper message, conventional mail letter or message, letter, telephone call, and/or any other manner and/or mode of communication.

The present invention can provide for, and can perform elective message tagging fulfillment services for, and regarding, messages and/or elective message tags which have flexibility as to when elective message tags are obtained and/or skipped while still providing the individual subscriber and/or registrant with the value of, and/or with the number of elective message tags for which the individual subscriber and/or registrant has contracted. The amount of subscription flexibility can be dictated by any party to the subscription and/or registration as part of the process of processing, fulfilling, and/or managing the subscription and/or registration.

The subscription and/or registration processing, fulfillment, and management computer-implemented system can provide elective message tagging services for any number and/or type of messages, in succession and/or in parallel, to any one or more individuals, communication devices, and/or communication accounts.

The apparatus and method of the present invention can provide for subscriptions and/or registrations for messages which can be initiated and/or created via any type of communication device and/or any type of point-of-sale transaction device, or e-commerce point-of-sale device.

The apparatus and method of the present invention can provide for services, operations, and/or functions regarding elective message tags to be processed, fulfilled, and/or managed by a plurality of communications devices, and/or point-of-sale devices, of which such communications and point-of-sale devices may be one in the same.

In the apparatus and method of the present invention, the delivery of the message associated with the elective message tag can be delivered, provided, transmitted, and/or serviced by any communications enabled system, and/or any communications entity, and/or other communications and/or messaging facility. In this manner, an individual subscriber and/or registrant may initiate a subscription and/or registration for an elective message tag and associate that elective message tag with any and all types of messages which can be transmitted either directly from one entity and/or individual and/or location and/or device to another, in any permutations of plurality of individuals, entities, locations, and/or devices, and/or either indirectly over a communications and/or computing network from one entity and/or individual and/or location to another, in a any permutations of plurality of individuals, entities, locations, and/or devices.

In the apparatus and method of the present invention can effectuate elective message tagging a single point of time, over a period of time, prior to a scheduled event, during a scheduled event, following a scheduled event, with a time delay, and/or at a predetermined time, and/or a random time. By example, elective message tagging may occur in such a manner, but is not limited to such messaging activities associated with transactions, transactions associated with online commerce, in-store commerce, point-of-sale machine transactions, e-commerce point-of-sale devices and/or systems, occurring at a commercial locations, and/or occurring either before, during, and/or after the transaction. In this manner, flexibility is provided regarding the timing of the elective message tagging delivery.

The subscriber, registrant, and/or agent thereof, and/or other third party intermediary, can access the computer-implemented subscription and/or registration processing, fulfillment, and management system and/or the computer-implemented subscription fulfillment system, via one of the herein referenced communication devices and/or via the point-of-sale transaction device so as to ascertain the status of a subscription and/or registration such as, but not limited to, whether the subscription is active or inactive, and/or the fulfillment status of the subscription and/or registration, such as, but not limited to, the number of messages remaining, type of messages remaining, time for next message, content associated with the parties to the messaging transaction.

The computer-implemented subscription and/or registration processing, fulfillment, and management system can also notify elective message tag subscribers and/or registrants via any means, method and/or manner of communication, via the communication device and/or the point-of-sale transaction device, of available elective message tags, of elective message tag promotions, of renewal notices, extension notices, termination notices, elective message tag creation and/or initiation notices, message and/or elective message tag delivery, and/or of any other information related to elective message tagging which may be of interest to an individual subscriber and/or registrant.

The apparatus and method of the present invention can be utilized as a messaging clearinghouse, to match elective message tag subscribers and/or registrants with messages, wherein information regarding any number of, and types of, messages can be stored in the computer-implemented subscription and/or registration processing, fulfillment, and management system. A subscriber and/or registrant to the elective message tagging service can access the respective computer-implemented subscription and/or registration processing, fulfillment, and management system and search for a desired elective message tag, brand, offer, promotion, incentive, company, organization, and/or entity offering elective message tags, elective message tag content, data, information, and/or related elective message tag services and/or products. The subscriber and/or registrant may then request, apply for, offer, counter-offer, and/or receive the elective message tag, and pursuant to the commercial terms between the parties, receive and/or make payment for, and/or receive and/or give consideration for, and/or purchase and/or sell an elective message tag and any and all associated data, information, and/or content as described herein. Similarly, an elective message tagging provider of data, information, and/or content as described herein can access the respective computer-implemented subscription and/or registration processing, fulfillment, and management system and search for a desired recipient of an elective message tag, brand, offer, promotion, incentive, company, organization, and/or entity offering elective message tags, elective message tag content, data, information, and/or related elective message tag services and/or products. The elective message tagging provider may then offer, counter-offer, deliver, and/or receive the elective message tag, and pursuant to the commercial terms between the parties, receive and/or make payment for, and/or receive and/or give consideration for, and/or purchase and/or sell an elective message tag and any and all associated data, information, and/or content as described herein. Furthermore, a subscriber and/or registrant can list a request and/or place an order for an elective message tag over the computer-implemented subscription and/or registration processing, fulfillment, and management system, and/or have it stored there, and/or have it paired, and/or designate criteria for having the request met. The computer-implemented subscription and/or registration processing, fulfillment, and management system can thereafter process the order and/or request, and/or execute the request, and/or notify the subscriber by any designated means including the subscriber's and/or registrant's communication device and/or the point-of-sale transaction device if, when, and under which terms the requested elective message tag is available. Similarly, an elective message tag provider can list a request and/or place an offer for an elective message tag over the computer-implemented subscription and/or registration processing, fulfillment, and management system, and/or have it stored there, and/or have it paired, and/or designate criteria for having the request met. The computer-implemented subscription and/or registration processing, fulfillment, and management system can thereafter process the order and/or request, and/or execute the request, and/or notify the elective message tag provider by any designated means including the elective message tag providers communication device and/or the point-of-sale transaction device if, when, and under which terms the requested elective message tag is being made available.

The apparatus and method of the present invention can be utilized in conjunction with a bidding service to match elective message tag subscribers and/or registrants with messages, wherein information regarding any number of, and types of, messages can be stored in the computer-implemented subscription and/or registration processing, fulfillment, and management system. A subscriber and/or registrant, and/or elective message tag provider, and/or elective message tag service provider, and/or provider of affiliated elective message tagging services can access the respective computer-implemented subscription and/or registration processing, fulfillment, and management system and place a bid on an elective message tag, and/or elective message tagging service, and/or an affiliated elective message tagging service and/or good. Similarly, the bidding service may also be used in conjunction with the search service. Likewise, an elective message tag subscriber, elective message tag provider, and/or elective message tag service provider, and/or elective message tag provider of affiliated services, can list and/or submit a bid for an elective message tag and/or elective message tag related service, over the computer-implemented subscription processing, computer-implemented subscription fulfillment, and computer-implemented subscription management system, and/or have it stored there, and/or have it paired, and/or designate criteria for having the bid accepted, the bid fulfilled, and/or the request met. The computer-implemented subscription and/or registration processing, fulfillment, and management system can thereafter process the order and/or request associated with the bid, and/or execute the request, and/or notify the elective message tag provider by any designated means including the elective message tag providers communication device and/or the point-of-sale transaction device if, when, and under which terms the requested elective message tag and/or elective message tag service is being made available.

The elective message tagging subscriber and/or registrant, and/or the elective message provider, and/or agent thereof, may be notified via electronic communications, telecommunications, digital communications, network based communications, instant message, blog, tweet, e-mail, electronic transmission, pager message, beeper message, telephone call, telephone message, letter, voice message, physical mail delivery, and/or via any other appropriate means, method and/or technique.

Any of the computer-implemented subscription and/or registration processing, fulfillment, and management system elements, the communication devices, and/or including the point-of-sale transaction device, and/or including the e-commerce enabled point-of-sale device and/or system can be programmed for automatic operation, self-activation, and/or programmed operation, and as well may be done so remotely over a network. The computer-implemented subscription and/or registration processing, fulfillment, and management system and/or the central subscription and/or registration fulfillment processing computer can be programmed to automatically generate and/or to transmit messages and/or notices to any of the elective message tagging subscribers, registrants, providers, service providers, commercial entities being represent by and/or affiliated with the elective message tagging, retailers, wholesalers, sellers and/or buyers of commercial goods and/or services, goods and/or services providers, regarding subscriptions and/or registrations, subscription and/or registration fulfillment, provisioning, and/or management functions and/or states, the availability of elective message tags, messages available for tagging, forecasts of messages available for tagging, calculations and/or analysis concerning elective message tags and/or messages being tagged, having been tagged, and/or potentially available for tagging, availability of goods and/or services which are the subject of an elective message tag.

It is another object of the present invention to provide for intelligent agents, software agents, algorithms, computer code, applications, applets, and/or mobile agents, which can be utilized so as to act on behalf of any of the parties and/or any of the respective computers and/or devices described herein.

Accordingly, it is another object of the present invention to provide when necessary an apparatus and a method for providing and/or fulfilling actual messaging services, including the actual transmission of messages, in conjunction with the enablement of the offering, provisioning, processing, fulfillment, and/or management of service related to the delivery and management of elective message tags.

It is another object of the present invention to provide an apparatus and a method for providing elective message tagging services in a network environment.

It is still another object of the present invention to provide an apparatus and a method for providing and/or fulfilling elective message tagging services which allows a subscriber and/or registrant, and/or agent thereof to control the manner in which the subscription and/or registration for messaging is delivered.

It is yet another object of the present invention to provide an apparatus and a method for providing, fulfilling, and/or managing elective message tagging services which provides for flexibility, as to time, location, and/or goods, and/or product, and/or services provider, and/or communications services provider, in the fulfillment of the elective message tagging service.

It is another object of the present invention to provide an apparatus and a method for providing, fulfilling, and/or managing elective message tagging services which provides for an elective message tag and/or tags which is/are characterized by a subscription and/or registration period, term and/or duration, which allows an individual subscriber and/or registrant to skip messages, which are the subject of the subscription and/or registration while still allowing the individual subscriber and/or registrant to obtain and/or to benefit from the value of the subscription and/or registration.

It is still another object of the present invention to provide an apparatus and a method for providing, fulfilling, and/or managing elective message tagging services which facilitates an initiation of a subscription and/or registration, a renewal of a subscription and/or registration, an extension of a subscription and/or registration, and/or the cancellation and/or termination of a subscription and/or registration.

It is yet another object of the present invention to provide an apparatus and a method for providing, fulfilling, and/or managing elective message tagging services which provides notification to a subscriber and/or registrant regarding messages, status of their message subscriptions and/or registrations, information regarding fulfillment of messaging subscriptions and/or registrations, and/or status of fulfillment of their message subscriptions and/or message registrations.

It is another object of the present invention to provide an apparatus and a method for providing, fulfilling, and/or managing elective message tagging services which provides for a flexible message subscription and/or registration as well as a flexible message fulfillment.

It is yet another object of the present invention to provide an apparatus and a method for providing, fulfilling, and/or managing messaging subscription and/or registration services which provides and/or processes message subscription initiations, renewals, extensions, and/or terminations.

It is another object of the present invention to provide an apparatus and a method for providing, fulfilling, and/or managing elective message tagging services which can be utilized in conjunction with point-of-sale transaction devices, personal computers, personal communication devices, public communication devices and/or kiosks.

It is still another object of the present invention to provide an apparatus and a method for providing, fulfilling, and/or managing elective message tagging services which can be utilized on, over, and/or in conjunction with, any communication system.

It is yet another object of the present invention to provide an apparatus and a method for providing, fulfilling, and/or managing elective message tagging services which can be utilized on, over, and/or in conjunction with, the Internet and/or the World Wide Web, and/or other communications and/or computing networks and/or systems described herein, and/or network linking communications devices and/or computing devices.

It is another object of the present invention to provide an apparatus and a method for providing, fulfilling, and/or managing elective message tagging services which provides for a computer-implemented method for processing, fulfilling, and managing elective message tagging related to any kind and/or type of messaging.

It is still another object of the present invention to provide an apparatus and a method for providing, fulfilling, and/or managing elective message tagging services which provides for processing of subscription and/or registration payment information, and/or payments, and/or settlement information, and/or settlements.

It is another object of the present invention to provide an apparatus and a method for providing, fulfilling, and/or managing elective message tagging services which provides a clearinghouse for matching elective message tagging subscribers and/or registrants to elective message tags, and/or offers for elective message tags.

It is another object of the present invention to provide an apparatus and a method for providing, fulfilling, and/or managing elective message tagging services which provides a clearinghouse for matching elective message tag providers to/with subscribers and/or registrants of/for elective message tags, and/or offers for elective message tags.

It is still another object of the present invention to provide an apparatus and a method for providing, fulfilling, and/or managing elective message tagging services which provides for an apparatus which is programmed to provide any of the functionality described herein.

It is yet another object of the present invention to provide an apparatus and a method for providing, fulfilling, and/or managing elective message tagging services which can be utilized in conjunction with intelligent agents, software agents, algorithms, computer code, applications, applets, and/or mobile agents, which can be utilized so as to act on behalf of any of the parties and/or any of the respective computers and/or devices described herein.

Other objects and advantages of the present invention will be apparent to those skilled in the art upon a review of the Description of the Preferred Embodiment taken in conjunction with the Drawings which will follow.

### BRIEF DESCRIPTION OF THE DRAWINGS

In the Drawings:

FIG. 1 illustrates the apparatus of the present invention, in block diagram form;

FIG. 2 illustrates the computer-implemented subscription processing system of FIG. 1, in block diagram form;

FIG. 3 illustrates the computer-implemented subscription fulfillment system of FIG. 1, in block diagram form;

FIG. 4 illustrates the communication device of FIG. 1, in block diagram form;

FIG. 5 illustrates the point-of-sale transaction device of FIG. 1, in block diagram form;

FIG. 6 illustrates a flow diagram of a preferred embodiment operation of the present invention in initiating a subscription;

FIGS. 7A and 7B illustrate a flow diagram of a preferred embodiment operation of the present invention in providing fulfillment services for a subscription;

FIGS. 8A and 8B illustrate a flow diagram of another preferred embodiment operation of the present invention in providing fulfillment services for a subscription;

FIG. 9 illustrates the computer-implemented subscription management system of FIG. 1, in block diagram form;

FIGS. 10A, 10B, and 10C illustrate a flow diagram of a preferred embodiment operation of the present invention in providing management services for a subscription;

FIG. 11 illustrates a flow diagram of a preferred embodiment operation of the present invention in fulfilling services for an elective message tag.

### DESCRIPTION OF THE PREFERRED EMBODIMENTS

The present invention pertains to an apparatus and method for providing elective message tagging that overcomes the shortcomings of the prior art. The present invention pertains to an apparatus and method for elective message tagging, which provides enhanced products and/or services for engineering, communications, entertainment, and other industries and individuals who or which utilize same.

The apparatus and method of the present invention, in a preferred embodiment, provides a system and/or platform to perform elective message tagging, controlled on the demand side and receiver and/or subscriber side of the message. By creating a mechanism with receiver and/or subscriber sided tagging that can be readily implemented in a plethora of applications and will enable the benefits of elective message tagging to be achieved by many more individuals in the systems, devices, and products they use.

The apparatus and method of the present invention, in a preferred embodiment, provides a computer-implemented system, comprising: receiving a request to receive one or more of a data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, and/or an embodiment of information, and/or an embodiment of control functionality, in conjunction with the delivery of a separate data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, and/or an embodiment of information, and/or an embodiment of control functionality; and transmitting a data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, and/or an embodiment of information, and/or an embodiment of control functionality in response to the request.

The apparatus and method of the present invention, in a preferred embodiment, provides a computer-implemented system, wherein one or more of the request, the fist message, and the second message are transmitted in conjunction with, on, or over, a plurality of communications and/or computing networks, and/or systems, which may include, but are not limited to, any one or any combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, geo synchronous satellite systems, as well as in, or on any internets and/or intranets, computing networks, cloud computing systems, servers, client devices, client-server architectures, quantum computers, quantum storage, communications networks, terrestrial networks, undersea networks, mobile networks, satellite networks, mesh networks, the Internet, World Wide Web, WWW2, WWW3, Semantic Web, closed circuit networks, open networks, radio networks, optical networks, pulse networks, digital networks, wave networks, light networks, neural networks, chemical networks, materials networks, biological networks, radiation networks, energy wave networks, and/or particle based networks, and/or where it may occur in a supra-global network environment, global network environment, trans-national network environment, national network environment, wide area network environment, metropolitan area network environment, local area network environment, personal network area environment, inter-being network environment, intra-being network environment, human-to-machine network environment, machine-to-machine network environment, and/or human-to-non-human network environment, and any other suitable communication network or system.

The apparatus and method of the present invention, in a preferred embodiment, provides a computer-implemented system, wherein one or more of the first message and/or second message are sent across the same network or at some point in the communication sent across different networks.

The apparatus and method of the present invention, in a preferred embodiment, provides a computer-implemented system, wherein the second message is sent as one or more of unsecured or secured by means of encryption.

The apparatus and method of the present invention, in a preferred embodiment, provides a computer-implemented system, wherein the second message which may be sent either directly from the first receiving party and/or via a third party to the subscriber and/or requestor.

The apparatus and method of the present invention, in a preferred embodiment, provides a computer-implemented system, wherein the device or devices associated with the requestor contain decryption software.

The apparatus and method of the present invention, in a preferred embodiment, provides a computer-implemented system for processing information for communicating a second message or messages, and/or message tag or message tags to the subscriber and/or requestor in conjunction with a first message.

The apparatus and method of the present invention, in a preferred embodiment, provides a computer-implemented system for processing information for creating or initiating a subscription and/or registration account for the requestor of and/or subscriber to the second message or messages, and/or message tag or message tags, and further enabling the control, monitoring, management, policies, practices, aggregation, dissolution, implementation, disallowance, restriction, and limitation functionality with respect to the message communications and/or transactions via the subscription and/or registration account, and further where such control, monitoring, management, policies, practices, aggregation, dissolution, implementation, disallowance, restriction, and limitation may be executed either under the direct control of the parties to the message or by intelligent agents, software agents, computer code, applications, applets, and/or mobile agents that may act on behalf of any of the parties and/or any of the respective computers and/or devices described herein.

The apparatus and method of the present invention, in a preferred embodiment, provides a computer-implemented system for storing one or more of the inventory of data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, and/or an embodiment of information, and/or an embodiment of control functionality, device and/or devices information associated with a subscriber and/or registrant, the contact information, account information, third-party account information, identification information of the subscriber and/or registrant, transaction information, requests, histories, and/or aggregated transaction data, of subscribers and/or registrants, and/or elective message tag providers, and/or message tag service providers, and/or third-party communications and/or computing entities facilitating the delivery of elective message tags.

The apparatus and method of the present invention, in a preferred embodiment, provides a computer-implemented system, wherein the subscription and/or registration is for a specified number of second messages, and/or elective message tags, and is for a specified time period, and further wherein one or more of the second messages, and or elective message tags, can be skipped or foregone in or during the specified time period while allowing a subscriber and/or registrant to be able to control the quantity or frequency in or during the specified time period.

The apparatus and method of the present invention, in a preferred embodiment, provides a computer-implemented system, wherein the request contains one or more of an access code, a password, a personal identification number or code, email address, uniform resource locator, telephone number, mobile telephone number, contact digital address, digital contact information, digital place of receipt, unique identifying information, a bar code, an optical code, a code for scanning, a biometric code, an avatar, an avatar identification, representative identification, third-party identification related to requestor, postal contact, and information obtained from a magnetic strip of an account card, information obtained from a microprocessor of an account card, or information from a subscriber identity module card, or information obtained from an electronic account previously associated with the subscriber and/or registrant.

The apparatus and method of the present invention, in a preferred embodiment, provides a computer-implemented system for processing information regarding a search for subject matter, subject matter of an elective message tag, and/or an elective message tag provider, messaging entity, identity, brand, category, product, service, and/or identifying information associated with either the subscriber and/or receiver, and/or the first message to be transmitted.

The apparatus and method of the present invention, in a preferred embodiment, provides a computer-implemented system for processing information regarding the pairing of offers for elective message tags with requests to receive elective message tags based on parameters set by the elective message tag provider, the elective message tag subscriber and/or the requestor, and or the elective message tag service provider.

The apparatus and method of the present invention, in a preferred embodiment, provides a computer-implemented system for a bidding system for sellers and buyers, and/or senders and recipients, and/or parties to the sending and receiving of the elective message tags, to reach a commercial agreement for sending and receiving elective message tags.

The apparatus and method of the present invention, in a preferred embodiment, provides a computer-implemented system further comprising a payment method or methods for settlement of accepted offers for receiving and/or transmitting elective message tags.

The apparatus and method of the present invention, in a preferred embodiment, provides a computer-implemented system for further determining that the subscription and/or registration is not active; and processing information for re-opening or renewing the subscription and/or registration.

The apparatus and method of the present invention, in a preferred embodiment, provides a computer-implemented system for generating a notification pursuant to any one or more of a subscription and/or registration request, a subscription and/or registration, subscription and/or notification rejection, a search, a query, a status, a payment, an acceptance, a conveyance, a counter-offer, a rejection, dynamically generated offer, dynamically generated acceptance, dynamically generated set of terms, and/or information and/or actions related to the processing, fulfillment, and/or management of elective message tagging services.

The apparatus and method of the present invention, in a preferred embodiment, provides a computer-implemented system for a processor, wherein the processor process a request to perform at least one action of register, subscribe, assess, communicate, attach a communication, attach a message tag to a communication, pair a communication and a message tag, forward a communication, forward a communication and a message tag, wherein the processor determines at least of one of authorization, authentication, whether to accept, reject, further qualify, and/or to facilitate a communication and/or multiple communications.

The apparatus and method of the present invention, in a preferred embodiment, provides a computer-implemented system for a processor, wherein the processor generates a notification to the requestor of approval, rejection, a query, or an offer pursuant to the requested elective message tag, and/or inventory status, pricing status, availability status.

The apparatus and method of the present invention, in a preferred embodiment, provides a computer-implemented system for a processor, wherein the processor processes a registration and/or subscription to an elective message tagging service.

The apparatus and method of the present invention, in a preferred embodiment, provides a computer-implemented system for a processor, wherein the processor processes the communications associated with the request to one or more of the requestor, and/or a third party messaging entity, and further wherein the processor facilitates the search, matches a buy and sell offers, and facilitates a transaction associated with the request to receive an elective message tag and/or elective message tags.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

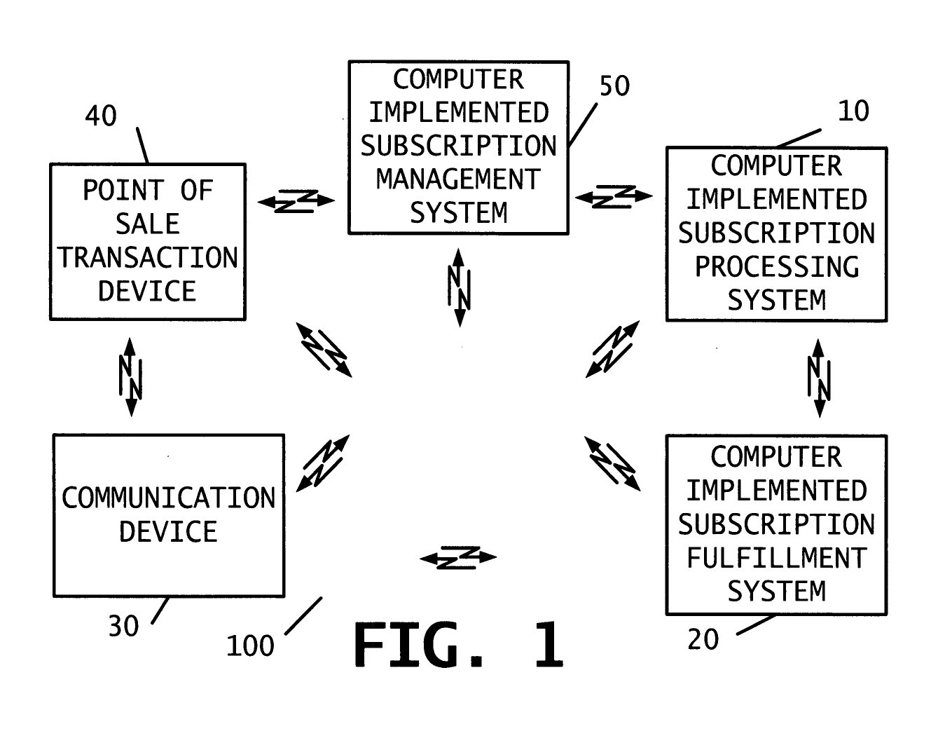

FIG. 1 illustrates the apparatus of the present invention in block diagram form. The apparatus is generally denoted by the reference numeral 100. The apparatus 1 includes a computer-implemented subscription processing system 10. The computer-implemented subscription processing system 10 processes subscription orders and/or subscription requests and establishes subscriptions and/or subscription accounts for the respective subscribers to any of the respective elective message tagging services, described herein.

The apparatus 1 also includes a computer-implemented subscription fulfillment system 20 which processes data and/or information regarding and/or involving fulfillment services for the respective subscriptions.

The apparatus 1 also includes a computer-implemented subscription management system 50 which processes data and/or information regarding and/or involving management services for the respective subscriptions.

In the preferred embodiment, each of the computer-implemented subscription processing system 10 and the computer-implemented subscription fulfillment system 20 and the computer-implemented subscription management system 50 are computers and/or computer systems and may be any suitable server computer, network computer, mainframe computer, mini-computer, personal computer, a microcomputer, a computer on a chip, a nano computer, and/or any other computer and/or computer system which is suitable for performing the respective processing functions of the respective computers in a network environment.

The apparatus 1 also includes a communication device 30 which, in the preferred embodiment, is utilized in order to communicate with each of the computer-implemented subscription processing system 10 and the computer-implemented subscription fulfillment system 20 and the computer-implemented subscription management system 50. In the preferred embodiment, the communication device can be a personal computer, a home computer, a microcomputer, a computer on a chip, a nano computer, a personal digital assistant, a mobile communications device, a telephone, a wireless telephone, a cellular telephone, a hand-held computer, a palm-top computer, and/or any other computer and/or communication device.

The communication device 30 is utilized, in the manner described herein, in order to communicate with the computer-implemented subscription processing system 10 and the computer-implemented subscription fulfillment system 20. In this regard, the communication device 30 can transmit signals to, as well as receive signals from, each of the computer-implemented subscription processing system 10 and the computer-implemented subscription fulfillment system 20 and the computer-implemented subscription management system 50.

The apparatus also includes a point-of-sale transaction device 40. The point-of-sale transaction device 40 processes point-of-sale transactions and/or retail transactions involving the respective elective message tagging services, which are the subject of the respective elective message tagging subscription. The point-of-sale transaction device 40 communicates with each of the computer-implemented subscription processing system 10 and the computer-implemented subscription fulfillment system 20 and the computer-implemented subscription management system 50. In this regard, the point-of-sale transaction device 40 can transmit signals to, as well as receive signals from, each of the computer-implemented subscription processing system 10 and the computer-implemented subscription fulfillment system 20 and the computer-implemented subscription processing system 50.

In the preferred embodiment, the point-of-sale transaction device 40 can transmit signals to, and receive signals from, the communication device 30. In this manner, any of the computer-implemented subscription processing system 10, the computer-implemented subscription fulfillment system 20, communication device 30, the point-of-sale transaction device 40, and/or the computer-implemented subscription management system may communicate with each other.

In the preferred embodiment, a plurality of point-of-sale devices 40 can be utilized, with each device 40 being utilized at and for a separate retail location or at a separate retail site at a retail location. The point-of-sale device 40 may be a communications and/or computing enabled kiosk. In the preferred embodiment, a plurality of communication devices 30 can be utilized with each communication device 30 being associated with a subscriber. The communication device 30 may also be a communications and/or computer enabled kiosk.

In yet another preferred embodiment, the point-of-sale devices 40 can be utilized in an online, and/or digital environment, with each device 40 being an e-commerce enabled point-of-sale device and/or system, and/or an e-commerce enabled network and/or platform, and/or an e-commerce enabled communications network and/or platform. The e-commerce enabled point-of-sale device 40 may be digitally located at and for a separate retail location or at a separate retail site at a retail location.

In yet another preferred embodiment, the communications device 30 and the point-of-sale device 40 may be one in the same.

The computer-implemented subscription processing system 10 may be a single computer and/or computer system and/or may include a plurality of computers and/or computer systems. In the same manner, the computer-implemented subscription fulfillment system 20 may be a single computer and/or computer system and/or may include a plurality of computers and/or computer systems. In the same manner, the computer-implemented subscription management system 50 may be a single computer and/or computer system and/or may include a plurality of computers and/or computer systems.

The apparatus 1 of the present invention, in the preferred embodiment, is utilized over any suitable communication network and/or system.

The communications networks and/or systems on, or over, which the present invention may be utilized in conjunction with, on, or over, a plurality of communications and/or computing networks, and/or systems, which may include, but are not limited to, any one or any combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, geo synchronous satellite systems, as well as in, or on any interacts and/or intranets, computing networks, cloud computing systems, servers, client devices, client-server architectures, quantum computers, quantum storage, communications networks, terrestrial networks, undersea networks, mobile networks, satellite networks, mesh networks, the Internet, World Wide Web, WWW2, WWW3, Semantic Web, closed circuit networks, open networks, radio networks, optical networks, pulse networks, digital networks, wave networks, light networks, neural networks, chemical networks, materials networks, biological networks, radiation networks, energy wave networks, and/or particle based networks, and/or where it may occur in a supra-global network environment, global network environment, trans-national network environment, national network environment, wide area network environment, metropolitan area network environment, local area network environment, personal network area environment, inter-being network environment, intra-being network environment, human-to-machine network environment, machine-to-machine network environment, and/or human-to-non-human network environment, and any other suitable communication network or system

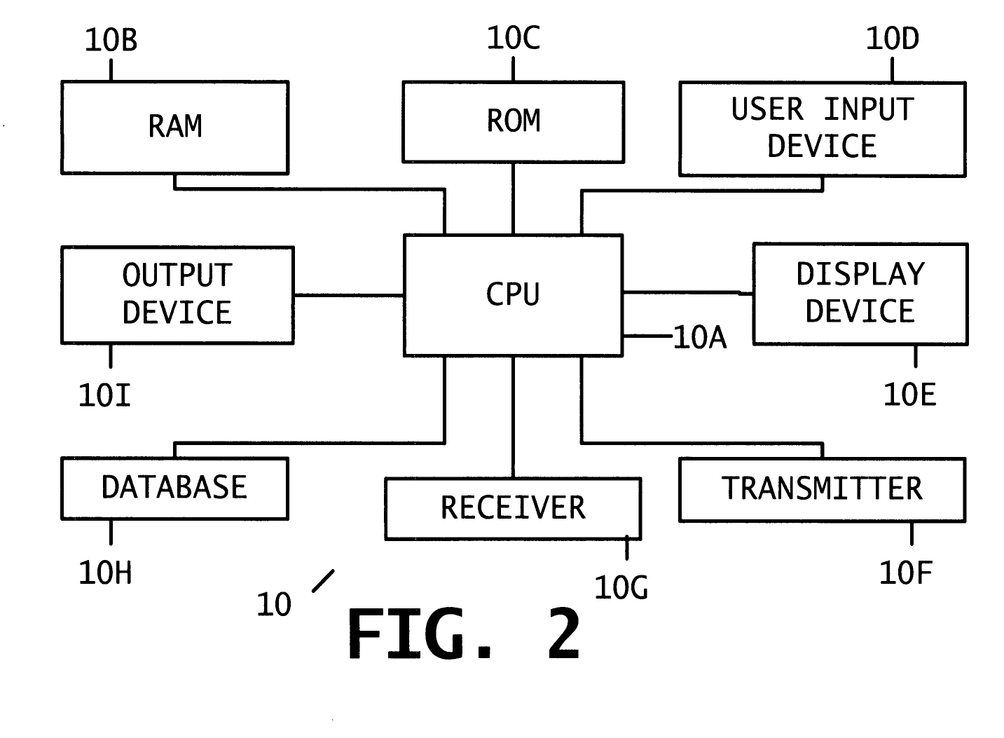

FIG. 2 illustrates the computer-implemented subscription processing system 10, in block diagram form. The computer-implemented subscription processing system 10, in the preferred embodiment, is a network computer or computer system which is utilized as a computer-implemented subscription processing system such as an server, servers in a datacenter, a web server, an Internet server computer, an e-commerce server computer, a communications server, a database server, a mobile computer, and/or any similar computer or computer system.

The computer-implemented subscription processing system 10 can also be any other computer or computer system which can be utilized in any computing and/or communication network. In the preferred embodiment, the computer-implemented subscription processing system 10 includes a central processing unit or CPU 10A, which in the preferred embodiment, is a microprocessor. The CPU 10A may also be a microcomputer, a minicomputer, a macro-computer, a computer on a chip, a nano computer, a synthetic computer, a biological computer, a multi-core computer, a multi-component computer, a physical computer, a virtualized computer, a single computer, a combination of computers, a computer system, a networked computer system, and/or a mainframe computer, depending upon the application.

The computer-implemented subscription processing system 10 also includes a random access memory device(s) 10B (RAM) and a read only memory device(s) 10C (ROM), each of which is connected to the CPU 10A, a user input device 10D, for entering data and/or commands into the computer-implemented subscription processing system 10, which includes any one or more of a key pad, a keyboard, a scanner, a touch pad, a signature pad, a card reader, a magnetic strip card reader, a biometric scanner, a subscriber identity module reader, a chip reader, a signal scanner, a camera, a video camera, a microphone, a graphic image and/or video signal generator, an audio signal and/or audio image generator, a user pointing device, such as, for example, a mouse, a touch pad, and/or an audio input device and/or a video input device, etc., if desired, which input device(s) is also connected to the CPU 10A.

The computer-implemented subscription processing system 10 also includes a display device 10E for displaying data and/or information to a user or operator.

The computer-implemented subscription processing system 10 also includes a transmitter(s) 10F, for transmitting signals and/or data and/or information to any one or more of the computer-implemented subscription processing system(s) 10, the computer-implemented subscription fulfillment system(s) 20, the computer-implemented subscription management system 50, the point-of-sale transaction devices 40, and the communication devices 30, which may be utilized in conjunction with the present invention. The computer-implemented subscription processing system 10 also includes a receiver 10G, for receiving signals and/or data and/or information from to any one or more of the computer-implemented subscription processing system(s) 10, the computer-implemented subscription fulfillment system(s) 20, the computer-implemented subscription management system 50, the point-of-sale transaction devices 40, and the communication devices 30, which may be utilized in conjunction with the present invention.

The computer-implemented subscription processing system 10 also includes a database 10H. The database can include data and/or information regarding elective message tag provider, or entity which provides data and/or information and/or functionality which may be either attached to, embedded in, and/or associated with the elective message tags, for which subscriptions are provided and/or available via the apparatus of the present invention. The database 10H can also include data and/or information regarding the services and/or products that may be provided in association with, and/or derived from, the elective message tagging services.

The database 10H can also include data and/or information regarding the subscriber, including all histories of usage, commercial terms, payments, technical, and/or communications usage in conjunction with the elective messaging tagging service. The database 10H can also include all data and/or information regarding the subscriber including all communications account information, financial account information, and a multitude of profiling information including, but not limited to, preferences, demographics, activity streams, behavioral targeting, data logging, digital footprint, lifelog, lifestreaming, profiling, runtime intelligence, social translucence, trace, trace evidence, genetic sequencing, psychographics, data represented in Attention Profiling Mark-up Language, subject and/or interest item information, communications, browsing histories, browsing patterns, documents, files, computational usage statistics, communications usage statistics, content created, content viewed, heard and/or read, content downloaded, applications used and/or downloaded, search queries, search results, click-through on search results, digital traces, activities, behaviors, login and logouts, visit of pages, documents accesses, items created, affiliation to groups, attention, social group, repetition, location, reputation, financial activities, investing activities, income data, spending data, consumption data, tax data, credit data, credit history data, reputational data, media related data, sensor discovered data, sensor recorded data, digital footprints, digital finger prints, life streams, social media linkages, social media activities, communications activities, computing activities, personal status, medical information, health information, personally identifiable information, volunteered information, collected information, rumored information, non-volunteered information, information capable of being stored in log files, information capable of being stored locally and/or or in a private and/or public cloud computing environment, information capable of being stored in databases, mined data, as well as the analytics associated with the aforementioned data and/or information, with respect to the services provided related to elective message tagging.

The database 10H can also include data and/or information regarding the services provided by the elective message tagging service provider, and/or affiliated service providers, including services previously offered, currently offered, and/or prospectively offered, content, communications, and/or commercial information regarding message tags including, but not limited to, data received by and/or from the elective message tag subscriber, data received by and/or from the elective message tag provider, and/or data generated by the elective message tag service provider through activities associated with the providing of elective message tagging services, as well as the analytics associated with any of the aforementioned data and/or information, with respect to the services provided related to elective message tagging.

The database 10H can also include data and/or information regarding the actual tag tags provided and/or offered by the elective message tag providers, including, but not limited to data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, and/or an embodiment of information, and/or an embodiment of control functionality, as well as the analytics associated with any of the aforementioned data and/or information, with respect to the services provided related to elective message tagging.

The database 10H also includes information regarding the elective message tagging subscriptions which each subscriber has subscribed to, type of subscription, subscription length or duration, subscription cost, subscription renewals, subscription extensions, elective message tags received and/or offered, status of subscription agreement, remaining subscription agreement commitments, and/or any other relevant information regarding the respective elective message tagging subscriptions and/or the fulfillment of the respective elective message tagging subscriptions.

The database 10H also includes information regarding the date the respective elective message tagging subscriptions were ordered, became effective, date of the start of the subscription, date of subscription termination, retailer and/or subscription origination agent from who the subscription originated, and the retailer, goods provider, and/or services provider, subscription service entity, and/or subscription fulfillment entity and/or agent from whom the subscriber will obtain the respective elective message tags, and/or elective message tagging services, which are be the subject of the elective message tagging subscriptions. The database 10H also includes information regarding customer service agents and/or entities for providing customer services for, and/or regarding, any of the respective elective message tagging subscriptions.

The database 10H may also contain any other information which may be relevant, pertinent, useful, and/or desired, for facilitating the operation of the apparatus and method of the present invention as described herein and/or as related thereto.

The database 10H, in the preferred embodiment, is a database which may include individual databases or collections of databases, with each database being designated to store any and all of the data and/or information described herein. Applicant hereby incorporates by reference herein the teachings of Basic Business Statistics Concepts and Applications, Mark L. Berenson and David M. Levine, 6.sup.th Edition, Prentice Hall 1996.

The database 10H, or collection of databases, may be updated by each of the respective individual subscribers, computer-implemented subscription processing system operator or administrator, computer-implemented subscription fulfillment system operator or administrator, computer-implemented subscription management system operator or administrator, point-of-sale transaction device operator, communication device operator or administrator, via any of their respective computers and/or devices, and/or by any other third party, in real-time, and/or via dynamically linked database management techniques.

The data and/or information stored in the database 10H can also be updated by external sources. The database 10H will contain any and all information deemed necessary and/or desirable for providing all of the processing and/or services and/or functions described herein. Applicant hereby incorporates by reference herein the subject matter of Fundamentals of Database Systems, by Ramez Elmasri and Shamkant B. Navathe, 2.sup.nd Ed., Addison-Wesley Publishing Company, 1994.

The database 10H can also include any contact information for any of the subscribers, subscription providers, subscription fulfillment providers, retailers, point-of-sale entities, etc., such as, but not limited to, names, addresses, telephone numbers, fax numbers, e-mail addresses, URL's, websites, hyper-links, XML data, personal identification information, business identification information, SIC codes, links to third-party and/or government sponsored identification information, and/or any other contact information, for the respective party. The database 10H also includes any of the above-described contact information regarding any intermediaries, third parties, agents, and/or brokers, who utilize the apparatus of the present invention.

The database 10H can also include any other data and/or information needed and/or desired for facilitating the functions and operation of the present invention as described herein.

With reference once again to FIG. 2, the computer-implemented subscription processing system 10 also includes an output device 101 such as a printer, a modem, a fax/modem, or other output device, for providing data and/or information to the operator or user of the computer-implemented subscription processing system 10 or to a third party or third party entity.

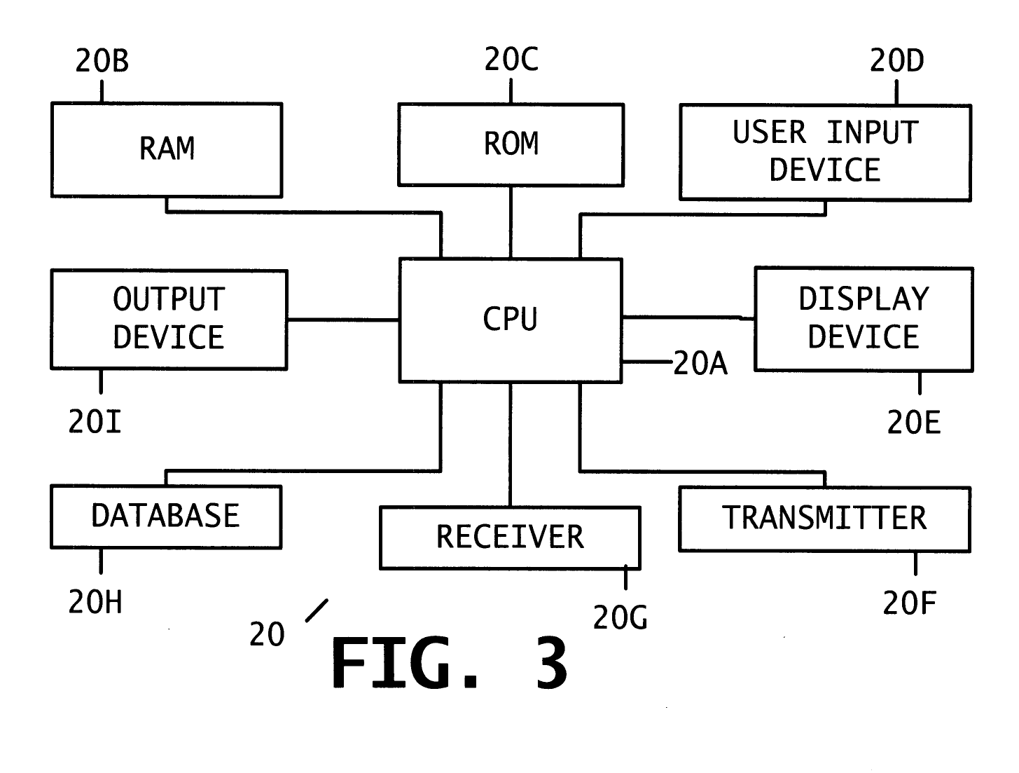

FIG. 3 illustrates the computer-implemented subscription fulfillment system 20, in block diagram form. The computer-implemented subscription fulfillment system 20, in the preferred embodiment, is a network computer or computer system which is utilized as a computer-implemented subscription fulfillment system such as an server, servers in a datacenter, a web server, an Internet server computer, an e-commerce server computer, a communications server, a database server, a mobile computer, and/or any similar computer or computer system.

The computer-implemented subscription fulfillment system 20 can also be any other computer or computer system which can be utilized in any computing and/or communication network. In the preferred embodiment, the computer-implemented subscription fulfillment system 20 includes a central processing unit or CPU 20A, which in the preferred embodiment, is a microprocessor. The CPU 20A may also be a microcomputer, a minicomputer, a macro-computer, a computer on a chip, a nano computer, a synthetic computer, a biological computer, a multi-core computer, a multi-component computer, a physical computer, a virtualized computer, a single computer, a combination of computers, a computer system, a networked computer system, and/or a mainframe computer, depending upon the application.

The computer-implemented subscription fulfillment system 20 also includes a random access memory device(s) 20B (RAM) and a read only memory device(s) 20C (ROM), each of which is connected to the CPU 20A, a user input device 20D, for entering data and/or commands into the computer-implemented subscription fulfillment system 20, which includes any one or more of a key pad, a keyboard, a scanner, a touch pad, a signature pad, a card reader, a magnetic strip card reader, a user pointing device, such as, for example, a mouse, a touch pad, and/or an audio input device and/or a video input device, etc., if desired, which input device(s) is also connected to the CPU 20A.

The computer-implemented subscription fulfillment system 20 also includes a display device 20E for displaying data and/or information to a user or operator.

The computer-implemented subscription fulfillment system 20 also includes a transmitter(s) 20F, for transmitting signals and/or data and/or information to any one or more of the computer-implemented subscription fulfillment system(s) 20, the computer-implemented subscription processing system(s) 10, the computer-implemented subscription management system(s) 50, the point-of-sale transaction devices 40, and the communication devices 30, which may be utilized in conjunction with the present invention. The computer-implemented subscription fulfillment system 20 also includes a receiver 20G, for receiving signals and/or data and/or information from to any one or more of the computer-implemented subscription fulfillment system(s) 20, the computer-implemented subscription processing system(s) 10, the computer-implemented subscription management system(s) 50, the point-of-sale transaction devices 40, and the communication devices 30, which may be utilized in conjunction with the present invention.

The computer-implemented subscription fulfillment system 20 also includes a database 20H. The database can include data and/or information regarding elective message tag provider, or entity which provides data and/or information and/or functionality which may be either attached to, embedded in, and/or associated with the elective message tags, for which elective message tagging subscriptions are provided and/or available via the apparatus of the present invention. The database 20H can also include data and/or information regarding the services and/or products that may be provided in association with, and/or derived from, the elective message tagging services.

The database 20H can also include data and/or information regarding the subscriber, including all histories of usage, commercial terms, payments, technical, and/or communications usage in conjunction with the elective messaging tagging service. The database 20H can also include all data and/or information regarding the subscriber including all communications account information, financial account information, and a multitude of profiling information including, but not limited to, preferences, demographics, activity streams, behavioral targeting, data logging, digital footprint, lifelog, lifestreaming, profiling, runtime intelligence, social translucence, trace, trace evidence, genetic sequencing, psychographics, data represented in Attention Profiling Mark-up Language, subject and/or interest item information, communications, browsing histories, browsing patterns, documents, files, computational usage statistics, communications usage statistics, content created, content viewed, heard and/or read, content downloaded, applications used and/or downloaded, search queries, search results, click-through on search results, digital traces, activities, behaviors, login and logouts, visit of pages, documents accesses, items created, affiliation to groups, attention, social group, repetition, location, reputation, financial activities, investing activities, income data, spending data, consumption data, tax data, credit data, credit history data, reputational data, media related data, sensor discovered data, sensor recorded data, digital footprints, digital finger prints, life streams, social media linkages, social media activities, communications activities, computing activities, personal status, medical information, health information, personally identifiable information, volunteered information, collected information, rumored information, non-volunteered information, information capable of being stored in log files, information capable of being stored locally and/or or in a private and/or public cloud computing environment, information capable of being stored in databases, mined data, as well as the analytics associated with the aforementioned data and/or information, with respect to the services provided related to elective message tagging.

The database 20H can also include data and/or information regarding the services provided by the elective message tagging service provider, and/or affiliated service providers, including services previously offered, currently offered, and/or prospectively offered, content, communications, and/or commercial information regarding message tags including, but not limited to, data received by and/or from the elective message tag subscriber, data received by and/or from the elective message tag provider, and/or data generated by the elective message tag service provider through activities associated with the providing of elective message tagging services, as well as the analytics associated with any of the aforementioned data and/or information, with respect to the services provided related to elective message tagging.

The database 20H can also include data and/or information regarding the actual tag tags provided and/or offered by the elective message tag providers, including, but not limited to data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, and/or an embodiment of information, and/or an embodiment of control functionality, as well as the analytics associated with any of the aforementioned data and/or information, with respect to the services provided related to elective message tagging.

The database 20H also includes data and/or information regarding the name of the respective elective message tags, and/or elective message tagging services, which can be the subject of the elective message tagging subscriptions. The database 20H also includes data and/or information regarding the types of subscription available for the respective elective message tags, and/or elective message tagging services, the length and/or duration of the respective elective message tagging subscriptions, the prices of the respective elective message tagging subscriptions, any conditions and/or miscellaneous information regarding the elective message tagging subscriptions available.

The database 20H also includes data and/or information regarding the individual subscribers, individuals, businesses, business entities, institutions, and/or others, who subscribe to any elective message tagging subscriptions via the apparatus of the present invention. The individual data and/or information can contain any pertinent information regarding the subscribers, such as sex, gender, age, educational level, occupation, marital status, and information regarding the subscriber's credit card(s), charge card(s), debit card(s), bank accounts, and/or other financial information for allowing the subscriber to pay for the respective elective message tagging subscriptions.

The database 20H also includes information regarding the elective message tagging subscriptions which each subscriber has subscribed to, type of subscription, subscription length or duration, subscription cost, subscription renewals, subscription extensions, elective message tags or portions of elective message tagging subscriptions used and still available, any/or any other relevant information regarding the respective elective message tagging subscriptions and/or the fulfillment of the respective elective message tagging subscriptions.

The database 20H also includes information regarding the elective message tagging subscriptions which each business subscriber has subscribed to, type of subscription, subscription length or duration, subscription cost, subscription renewals, subscription extensions, elective message tags or portions of elective message tagging subscriptions used and still available, any/or any other relevant information regarding the respective elective message tagging subscriptions and/or the fulfillment of the respective elective message tagging subscriptions.

The database 20H also includes information regarding the date the respective elective message tagging subscriptions were ordered, became effective, date of the start of the subscription, date of subscription termination, retailer and/or subscription origination agent from who the subscription originated, and the retailer, goods provider, and/or services provider, subscription service entity, and/or subscription fulfillment entity and/or agent from whom the subscriber will obtain the respective elective message tags, and/or elective message tagging services, which are be the subject of the elective message tagging subscriptions. The database 20H also includes information regarding customer service agents and/or entities for providing customer services for, and/or regarding, any of the respective elective message tagging subscriptions.

The database 20H may also contain any other information which may be relevant, pertinent, useful, and/or desired, for facilitating the operation of the apparatus and method of the present invention as described herein and/or as related thereto.

The database 20H, in the preferred embodiment, is a database which may include individual databases or collections of databases, with each database being designated to store any and all of the data and/or information described herein.

The database 20H, or collection of databases, may be updated by each of the respective individual subscribers, computer-implemented subscription processing system operator or administrator, computer-implemented subscription fulfillment system operator or administrator, computer-implemented subscription management system operator or administrator, point-of-sale transaction device operator, communication device operator or administrator, via any of their respective computers and/or devices, and/or by any other third party, in real-time, and/or via dynamically linked database management techniques.

The data and/or information stored in the database 20H can also be updated by external sources. The database 20H will contain any and all information deemed necessary and/or desirable for providing all of the processing and/or services and/or functions described herein.

The database 20H can also include any contact information for any of the subscribers, subscription providers, subscription fulfillment providers, retailers, point-of-sale entities, etc., such as, but not limited to, names, addresses, telephone numbers, fax numbers, e-mail addresses, URL's, websites, hyper-links, XML data, personal identification information, business identification information, SIC codes, links to third-party and/or government sponsored identification information, and/or any other contact information, for the respective party. The database 20H also includes any of the above-described contact information regarding any intermediaries, third parties, agents, and/or brokers, who utilize the apparatus of the present invention.

The database 20H can also include any other data and/or information needed and/or desired for facilitating the functions and operation of the present invention as described herein.

With reference once again to FIG. 3, the computer-implemented subscription fulfillment system 20 also includes an output device 201 such as a printer, a modem, a fax/modem, or other output device, for providing data and/or information to the operator or user of the computer-implemented subscription fulfillment system 20 or to a third party or third party entity.

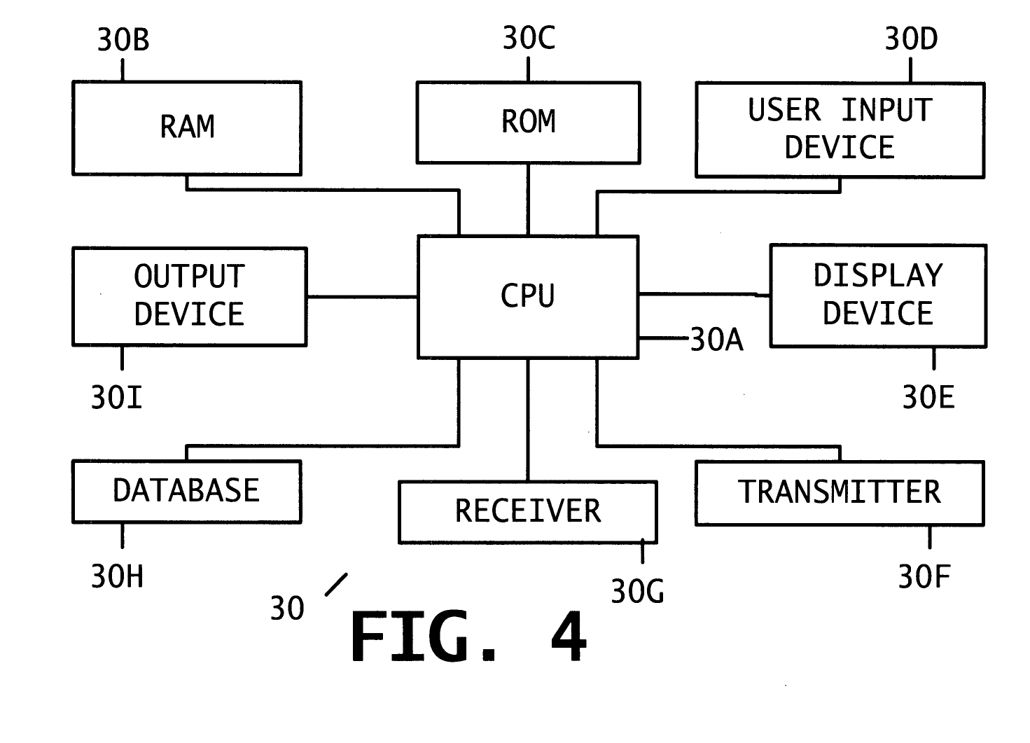

FIG. 4 illustrates the communication device 30, in block diagram form. The communication device 30, in the preferred embodiment, is a personal computer, a mobile phone, a smart phone, a mobile entertainment unit, a game console, a video terminal, an audio terminal, a digital communications system, a digital media screening room, a communications enabled garment, a communications enabled vehicle, a communications enabled premise, a communications enabled object, a communications enabled item, a communications enabled avatar, a communications enabled virtual being, a communications enabled virtual premise, a communications enabled virtual event, a communications enabled virtual vehicle, a communications enabled virtual object, a pager, a monitor, a control device, a personal digital assistant, a communication device, and/or any other suitable computer or communication device which can be utilized to access and/or to communicate with any of the computer-implemented subscription processing system(s) 10, computer-implemented subscription fulfillment system(s) 20, and/or any of the point-of-sale transaction devices 40, described herein. In the preferred embodiment, the communication device 30 includes a central processing unit or CPU 30A, which in the preferred embodiment, is a microprocessor. The CPU 30A may also be a microcomputer, a minicomputer, a macro-computer, a computer on a chip, a nano computer, a synthetic computer, a biological computer, a multi-core computer, a multi-component computer, a physical computer, a virtualized computer, a single computer, a combination of computers, a computer system, a networked computer system, and/or a mainframe computer, depending upon the application.

The communication device 30 also includes a random access memory device(s) 30B (RAM) and a read only memory device(s) 30C (ROM), each of which is connected to the CPU 30A, a user input device 30D, for entering data and/or commands into the communication device 30, which includes any one or more of a microphone, video camera, sensor, motion sensor, touch sensors of for the purpose of sensing such signals as, but not limited to, digital and/or electronic and/or audio and/or video and/or voice and/or tactile and/or image and/or gestation and/or olfacaction and/or equilibrioception and/or thermoception and/or proprioception and/or nociception and/or interoception and/or echolocation and/or electroception and/or magnetoception and/or pressure detection and/or current detection and/or polarized light direction detection and/or slit sensillae and/or vibratory and/or radiation and/or energy waves and/or particles, and as well may include a key pad, a keyboard, a scanner, a touch pad, a signature pad, a card reader, a magnetic strip card reader, a user pointing device, such as, for example, a mouse, a touch pad, and/or an audio input device and/or a video input device, etc., if desired, which input device(s) is also connected to the CPU 30A. The communication device 30 also includes a display device 30E for displaying data and/or information to an individual user or operator.

The communication device 30 also includes a transmitter 30F, for transmitting signals and/or data and/or information to any one or more of the computer-implemented subscription processing system 10, the computer-implemented subscription fulfillment system 20, the computer-implemented subscription management system 50, and/or to any of the point-of-sale transaction devices 40, which may be utilized in conjunction with the present invention. The communication device 30 also includes a receiver 30G, for receiving signals and/or data and/or information from any one or more of the computer-implemented subscription processing system 10, the computer-implemented subscription fulfillment system 20, the computer-implemented subscription management system 50, and/or to any of the point-of-sale transaction devices 40, which may be utilized in conjunction with the present invention.

The communication device 30 also includes a database(s) 30H which can contain any and/or all of the data and/or information described herein as being stored in the databases of computer-implemented subscription processing system(s) 10, the computer-implemented subscription fulfillment system(s) 20, the computer-implemented subscription management system, and/or any of the point-of-sale transaction devices 40, described herein.

With reference once again to FIG. 4, the communication device 30 also includes an output device 30I such as a printer, a modem, a fax/modem, or other output device, for providing data and/or information to the operator or user of the communication device 30 or to a third party or third party entity.

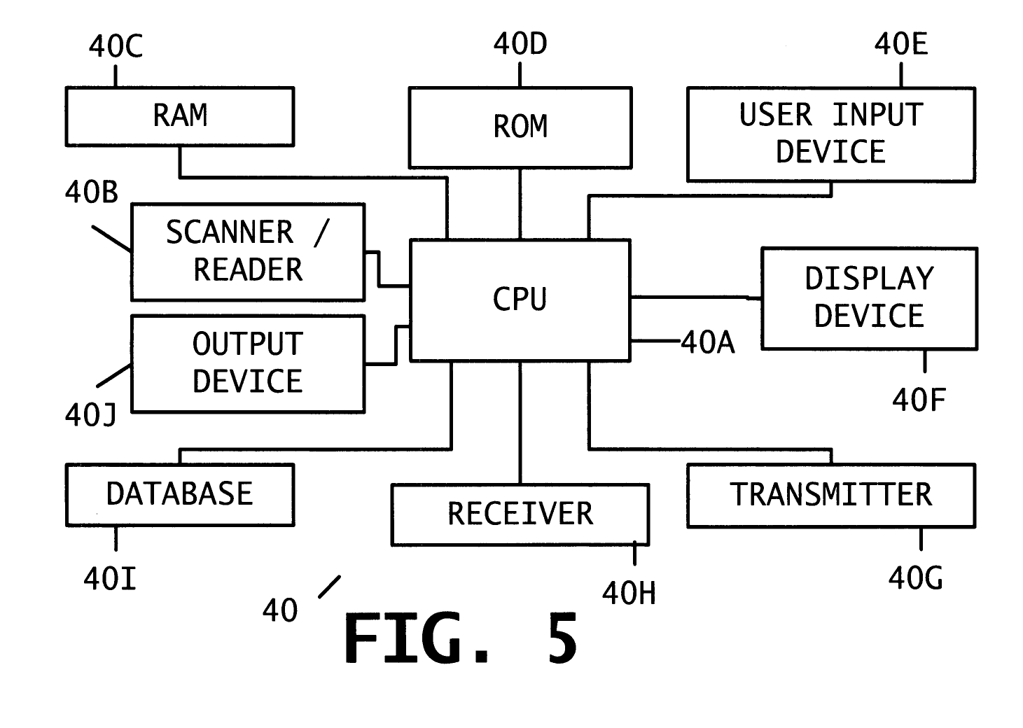

FIG. 5 illustrates the point-of-sale transaction device of FIG. 1, in block diagram form. In FIG. 5, the point-of-sale transaction device 40, in the preferred embodiment, includes a central processing unit or CPU 40A, a scanner/reader 40B, for scanning and/or reading any of the credit cards, charge cards, debit cards, value cards, smart cards, etc, which may be utilized in conjunction with the present invention. The scanner/reader 40A is connected to the CPU 40A. The point-of-sale transaction device 40 also includes associated random access memory 40C (RAM) and read only memory 40D (ROM) devices, which are also connected to the CPU 40A, a user input device 40E, which is typically any one or more of a key pad, a keyboard, a scanner, a touch pad, a signature pad, a card reader, a magnetic strip card reader, a user pointing device, such as, for example, a mouse, a touch pad, and/or an audio input device and/or a video input device, etc., if desired, or other suitable input device for inputting data into the point-of-sale transaction device 40 and which is also connected to the CPU 40A, and a display device 40F for displaying information and/or data to a user or operator, which display device 40F is also connected to the CPU 40A.

The point-of-sale transaction device 40 also includes a transmitter 40G for transmitting signals and/or data to the computer-implemented subscription processing system 10, the computer-implemented subscription fulfillment system 20, and/or the communication device 30 and/or to any other device associated with any of the subscription providers, the subscription fulfillment providers, and/or the subscribers described herein. The transmitter 40G is also connected to the CPU 40A. The point-of-sale transaction device 40 also includes a receiver 40H for receiving signals and/or data from any of the computer-implemented subscription processing system 10, the computer-implemented subscription fulfillment system 20, computer-implemented subscription management system 50, and/or the communication device 30, and/or to any other device associated with any of the subscription providers, the subscription fulfillment providers, and/or the subscribers described herein. The receiver 40H is also connected to the CPU 40A.

The point-of-sale transaction device 40 also includes a database 401. The database 401 can include any of the data and/or information described herein as being stored and/or which can be stored in the databases 10H, 20H, 50H, and/or 30H, of the respective computer-implemented subscription processing system 10, the computer-implemented subscription fulfillment system 20, the computer-implemented subscription management system 50, and/or the communication device(s) 30, described herein.

The point-of-sale transaction device 40 also includes a printer 40J or other appropriate output device for outputting data to the operator. The printer 40J is also connected to the CPU 40A. In the preferred embodiment, the printer 40J prints receipts corresponding to any of the subscription transactions described herein as capable of being performed by the present invention.

The apparatus and method of present invention can be utilized in order to order and/or to initiate elective message tagging subscriptions, to renew elective message tagging subscriptions, to extend elective message tagging subscriptions, to cancel and/or to terminate elective message tagging subscriptions, and/or to service and/or to fulfill elective message tagging subscriptions, and/or to manage elective message tagging subscriptions and/or services, for any of the subscription, and for any of the services and/or products which can be the subject of the respective elective message tagging subscriptions.

The apparatus and method of the present invention facilitates the servicing and/or fulfillment of elective message tagging subscriptions in a network environment. The apparatus and method of the present invention also facilitates providing elective message tagging subscriptions which have flexibility in the servicing and/or fulfillment of same as well as facilitates providing elective message tagging subscriptions which have flexibility in the length and/or the duration of the subscription.

The apparatus and method of the present invention also provides a computer-implemented elective message tag processing system 10, a computer-implemented elective message tag fulfillment system 20, and a computer-implemented elective message tag management system 50, any or all of whom can perform the functions of a clearinghouse for elective message tags. The apparatus and method of the present invention also provides notification to subscribers and/or other parties regarding subscription offers, changes and/or information regarding an event, occurrence and/or happening regarding any of the elective message tagging subscriptions and/or any of the services described herein.

In the herein-described preferred embodiment operations of the present invention, the present invention can be utilized in conjunction with elective message tagging subscriptions involving, but not limited to, data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, and/or an embodiment of information, and/or an embodiment of control functionality, as well as the analytics associated with any of the aforementioned data and/or information, ands/or any other commercial and/or informational and/or entertainment data and/or content (hereinafter referred to collectively as “message” or “messages”).

The subscription can be for conventional printed messages, messages in electronic form or “e-messages”, and/or messages in any other form. Although described as being utilized in conjunction with elective message tagging subscriptions for messages, the preferred embodiment operations of the present invention can be utilized in conjunction with elective message tagging subscriptions regarding any good and/or service which can be the subject of commerce. In this regard, the elective message tagging subscriptions described herein can involve, but not be limited to, elective message tagging subscriptions for and/or regarding movie rentals, video rentals, movie tickets, show tickets, airline tickets, bus tickets, gasoline purchases, postage stamps and/or postage, meals tickets, tickets to sporting events, tickets to entertainment events, tickets to theater performances, professional services, contracted for services, and/or any other good and/or service which can be the subject of commerce.

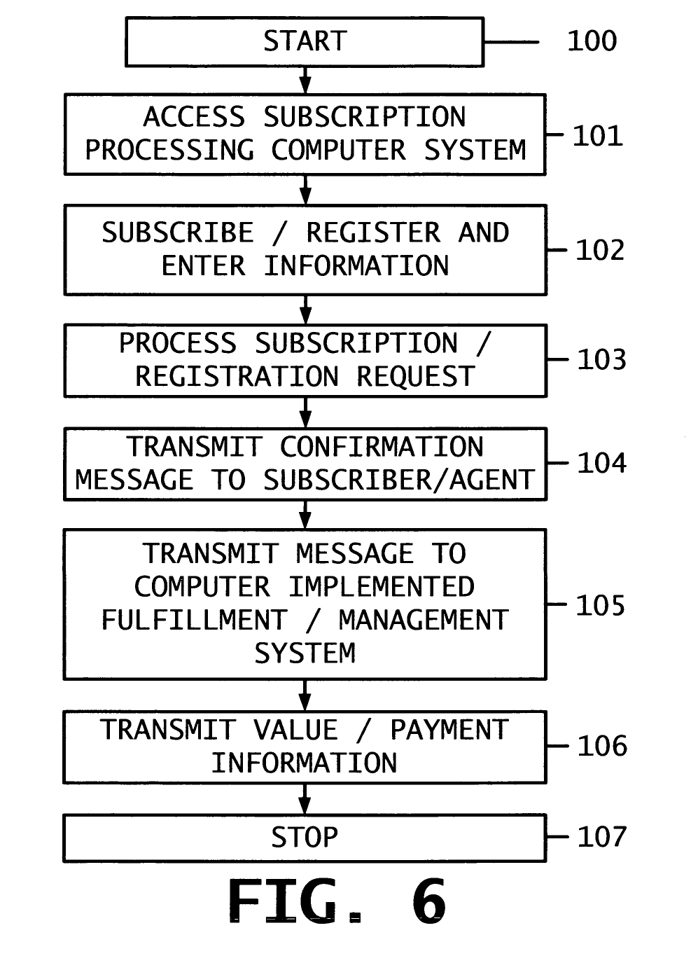

FIG. 6 illustrates a flow diagram of a preferred embodiment operation of the present invention in creating and/or initiating a subscription to a message. In a preferred embodiment, the apparatus can initiate and/or create a subscription which allows the individual subscriber to receive the elective message tags at a retail facility, such as at a kiosk, a store, a theater, a stadium, etc., thereby allowing the individual subscriber the freedom and convenience of receiving elective message tags at any desired time and/or from any desired retail facility.

The apparatus can also initiate and/or create a subscription which can be a conventionally deliverable subscription which can be initiated and/or created via an on-line transaction and which allows the individual subscriber to dictate subscription parameters such, but not limited to, subscription conditions, subscription terms of agreement, payment terms, payment methods, subscription term or period, and/or in any other manner described herein.

Operation of the apparatus commences at step 100. At step 101, the individual subscriber can access the computer-implemented subscription processing system 10 via either the respective communication device 30 and/or the point-of-sale transaction device 40. In an alternative embodiment, the computer-implemented subscription processing system 10 can contact the subscriber via the subscriber's communication device 30.

At step 102, the individual subscriber, the respective communication device 30 or point-of-sale device 40, can select the message or messages which the individual subscriber wishes to subscribe to and/or receive. At step 102, the individual subscriber also enters and or selects the term of the subscription and/or the number of elective message tags for which the individual subscriber wishes to subscribe. The individual subscriber can also, at step 102, enter or select a receipt of payment method which may include receipt of payment by credit card, charge card, debit card, direct withdrawal from checking account or savings account, cash receipt of payment at the retail location and/or at the location of the point-of-sale transaction device 40, and/or via electronic money, electronic cash, electronic check, digital money, and/or digital cash, and/or via with any authorization to receive payments towards any of the herein-described accounts, via the respective communication device 30 and/or point-of-sale transaction device 40. The individual subscriber may also, at step 102, enter or select to receive payment for the receiving of the elective message tag on a per tag basis, and/or on some multiple of tags basis, and/or for some number of actions taken as a result of the receipt of the elective message tag, such as, but not limited to, making purchases, viewing content, making recommendations, responding to a message tag, forwarding a message tag, acknowledging a message tag, scanning a message tag, and/or on some basis which acknowledges their commercial relationship with the elective message tag provider.

At step 102, the individual subscriber may also select the manner and/or mode by which he, she, or it, desires to effect subscription transactions. The individual subscriber may elect to effect elective message tagging transactions, such as receiving an installment of a multi-part message tag, such as in a marketing and/or political campaign, and/or the entire message tag, and thus accounting for such partial and/or full deliveries, and as well, the subscriber my effect elective message tagging delivery by utilizing an on-demand function, thus requesting the delivery of an elective message tag by sending a corresponding command via communication device 30, and/or point-of-sale device 40, and whereby they may also utilize an access code or personal identification number (PIN) or code, by utilizing an account card having account and/or subscription information embedded in a magnetic strip or in an embedded microprocessor or micro-controller, by utilizing a credit card, a charge card, a debit card and/or any other device or entity for allowing the individual subscriber to effect a subscription transaction at the respective point-of-sale transaction device 40 and/or at the respective communication device 30.

At step 102, the individual subscriber can also enter and/or select any other information and/or instructions regarding the subscription, such as, for example, the number of elective message tags desired, the length or duration of the subscription, the premise, the vehicle, the environment, the circumstances, the kiosk, the retail center and/or business where the individual subscriber desires or expects to receive and/or receive the elective message tag or elective message tags of the subscription message, and/or the retailer and/or business from which the individual subscriber desires and/or expects to receive delivery of the elective message tags. The number of elective message tags, the length or duration of the subscription, and/or the servicing and/or fulfillment services and/or conditions, can be flexible and can be changed by the individual subscriber at any time and from any point-of-sale transaction device 40 and/or from any communication device 30 described herein.

At step 102, the individual subscriber may also have the various elective message tag delivery functions, subscription functions, commercial activities, and/or processes executed dynamically through the configuration of the subscription settings in the subscription account via the computer-implemented subscription processing system 10, the computer-implemented subscription fulfillment system 20, and/or the computer-implemented subscription management system 50.

In this manner, the apparatus and method of the present invention can be utilized to provide for flexible elective message tagging subscriptions and/or for flexibility in the servicing and/or fulfillment and/or management of any of the elective message tagging subscriptions.

At step 103, the computer-implemented subscription processing system 10, will process the subscription request and/or any other information and/or instructions entered and/or elected at step 102 and create the desired subscription.

At step 104, the computer-implemented subscription processing system 10 will transmit an appropriate confirmation message to the individual subscriber at the respective communication device 30 and/or at the respective point-of-sale transaction device 40, notifying the individual subscriber of the creation and/or the initiation of the subscription. At step 105, the computer-implemented subscription processing system 10 will transmit an appropriate message and/or signal to the computer-implemented subscription fulfillment system 20, and/or to the computer-implemented subscription management system 50, to arrange for the fulfillment of the respective subscription. Steps 104 and 105 may be interchanged and, therefore, can be performed in any order.

At step 106, the computer-implemented subscription processing system 10 will transmit information, and/or any appropriate account information, financial account information, communications account information, and/or subscriber and/or registrant account information, account card, smart card, and/or debit card, and/or any electronic and/or digital signals for programming any of the respective financial accounts, communications accounts, and/or subscriber and/or registrant accounts, account card, smart card, and/or debit card, with any respective value for effecting the transactions pursuant to the subscription to any one or more of the subscriber of the elective message tagging service, the elective message tag provider, and/or the elective message tag service provider, and/or agents or third-parties acting on their behalf. The respective communication devices 30 and/or point-of-sale transaction devices 40 can also include any appropriate device for programming and/or transferring subscription information and/or value to any of the respective financial accounts, communications accounts, and/or subscriber and/or registrant accounts, account cards, smart cards, and/or debit cards, described herein.

In any and/or all of the embodiments described herein, any of the communications which occur and/or which transpire between any of the computers and/or devices 10, 20, 30, 40 and/or 50, described herein, and/or which occurs between any individual subscribers and/or operators and/or administrators of any of the computers and/or devices 10, 20, 30, 40 and/or 50, can be effected by or via electronic mail (e-mail), electronic message transmission, short message service, electronic data transfer, electronic payment system, digital payment system, digital communications system, digital communications service, telephone message, voice mail message, pager message, beeper message, conventional mail letter or message, letter, telephone call, and/or any other manner and/or mode of communication.

Once step 106 is completed, the subscription will be activated. Thereafter, the operation of the portion of the apparatus related to the herein description of functionality will cease at step 107.

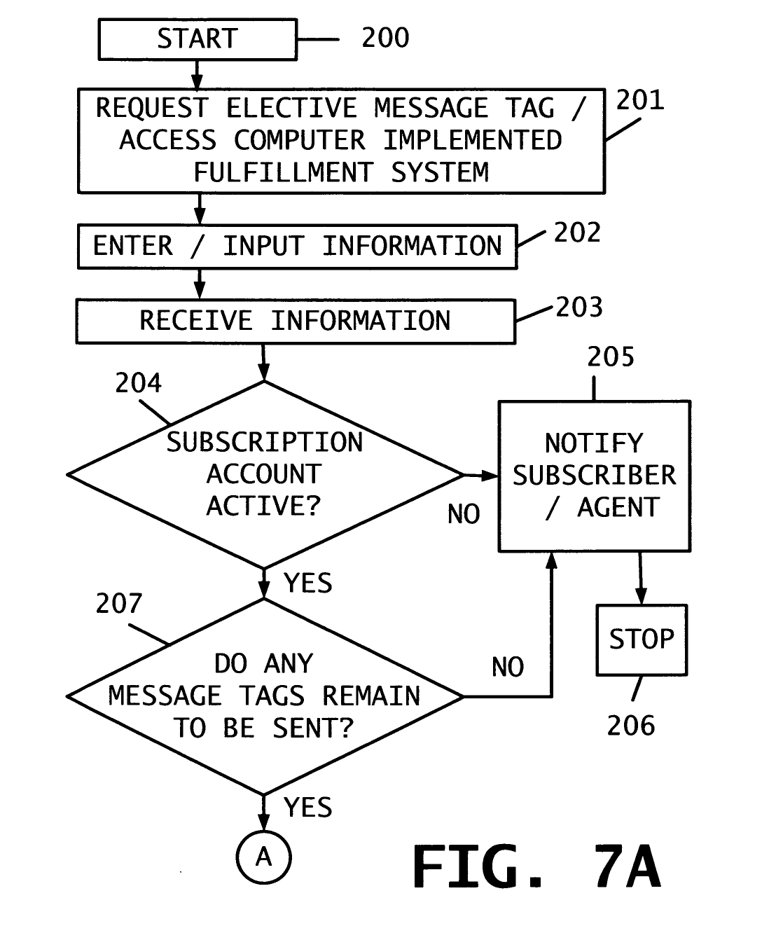

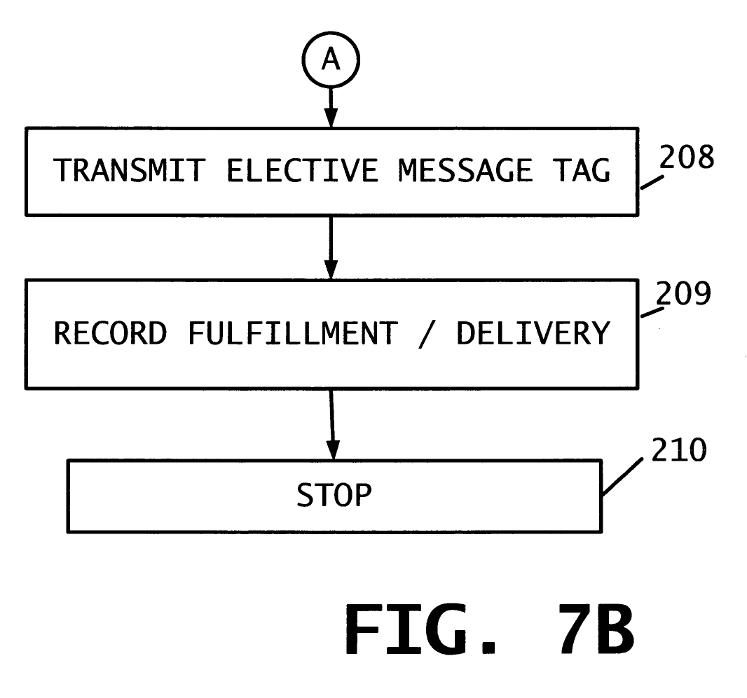

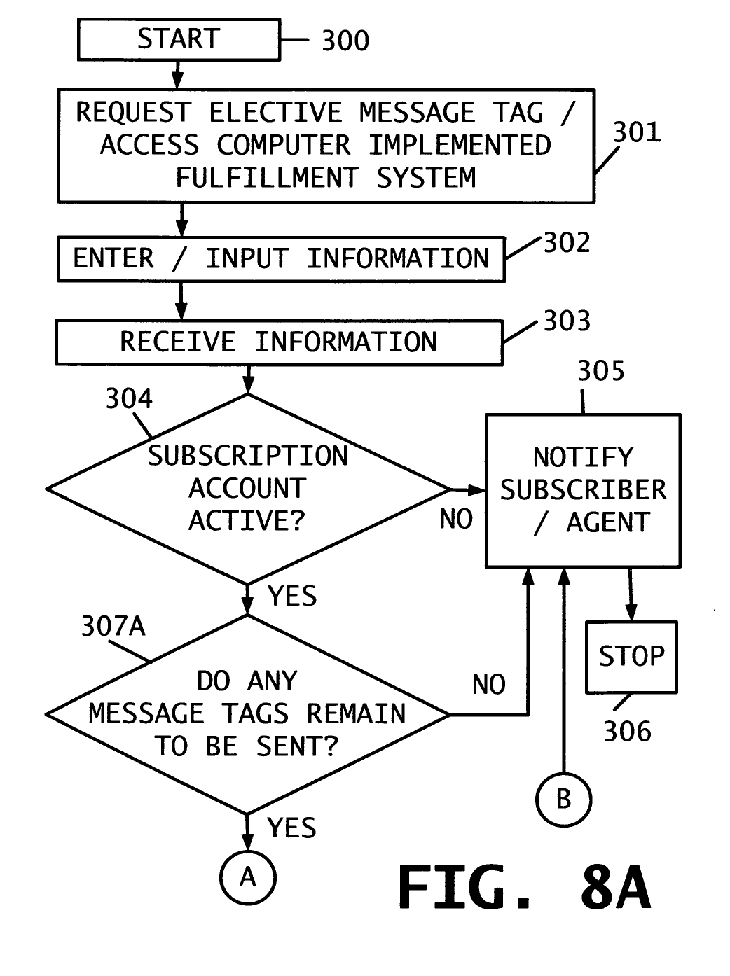

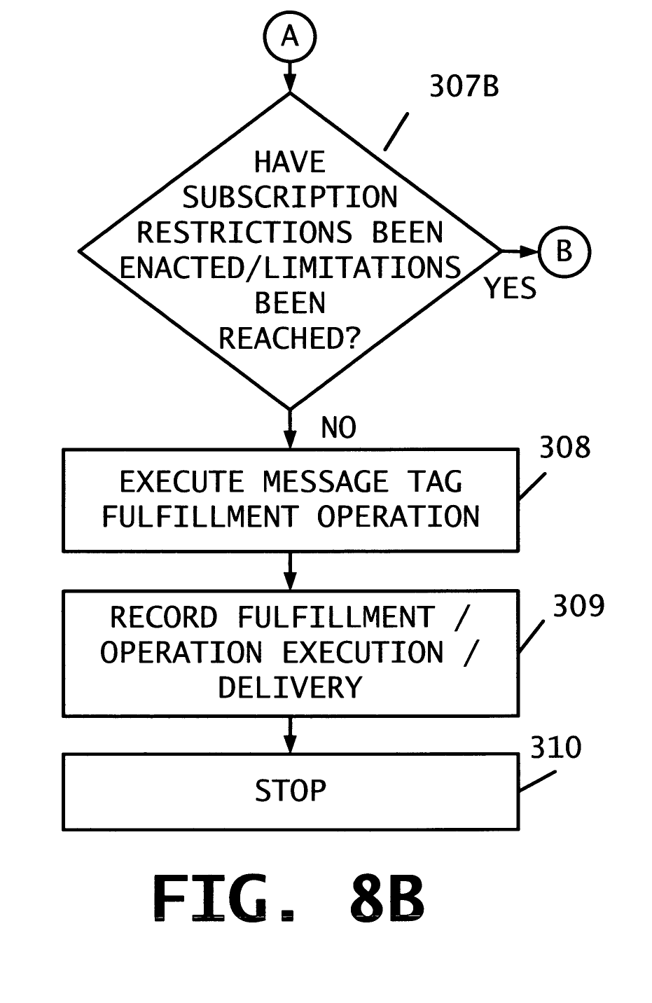

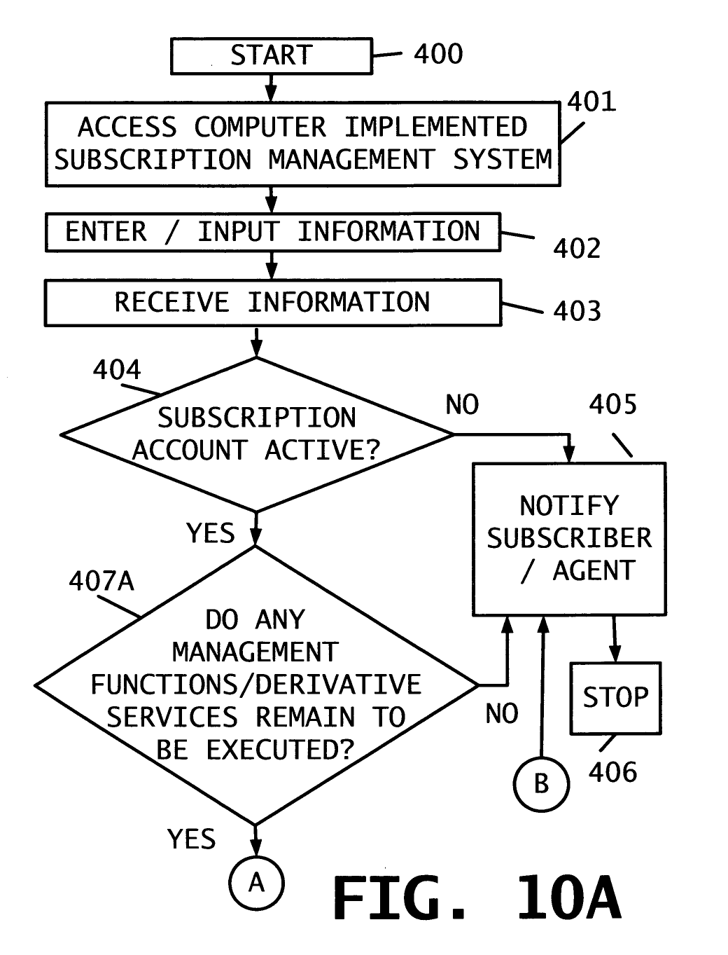

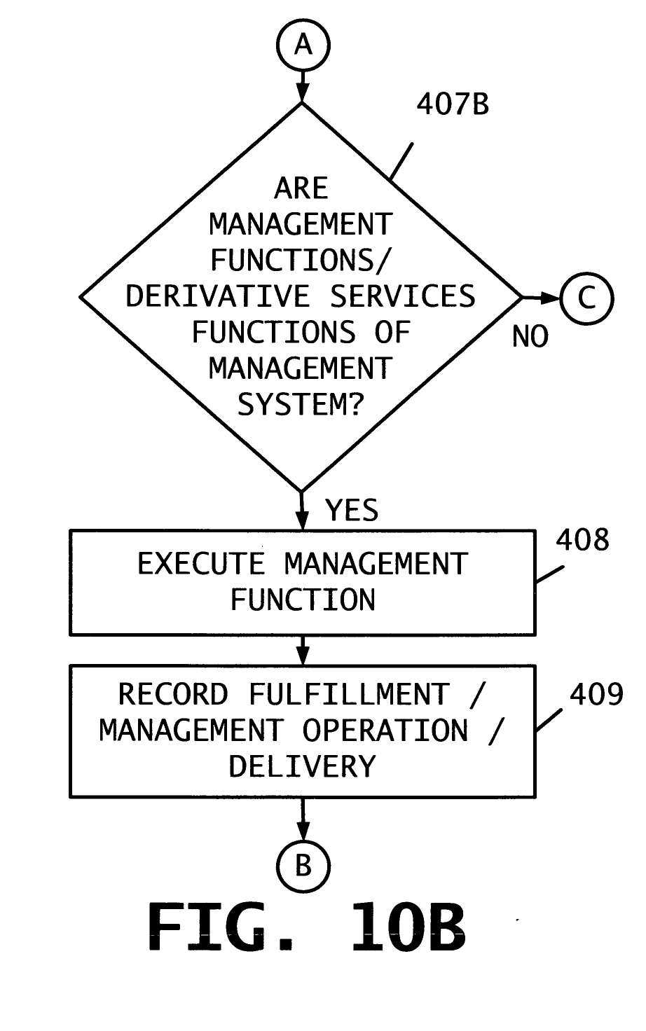

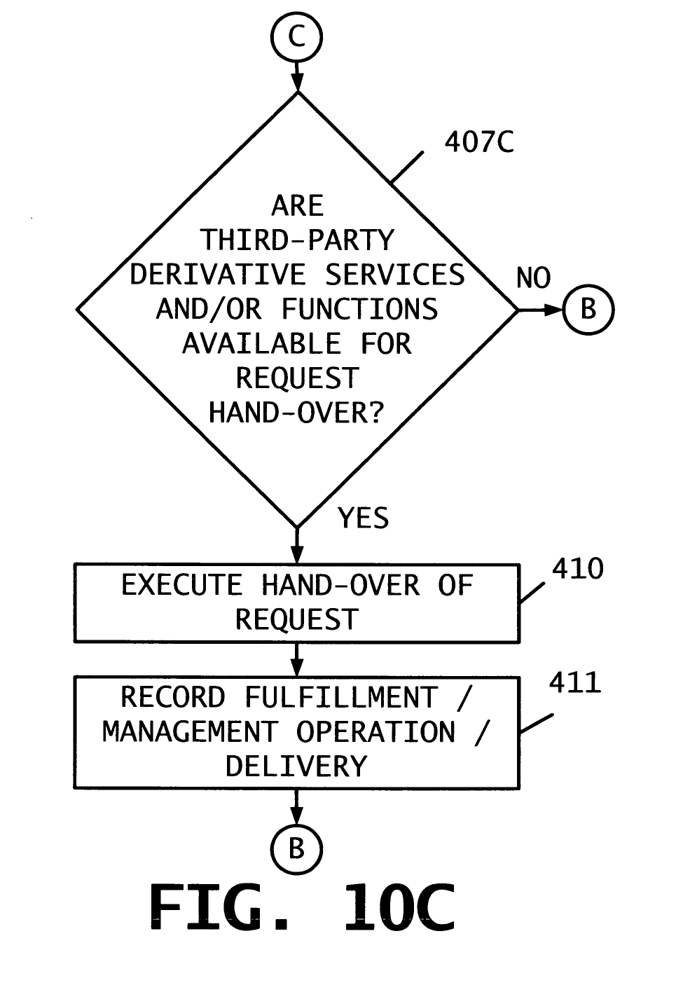

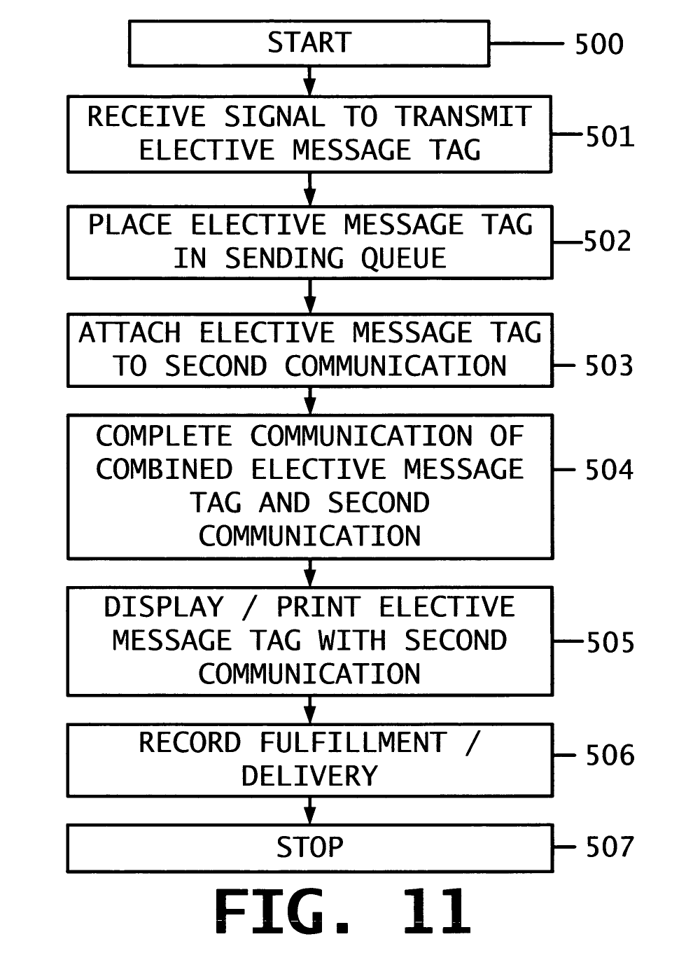

Thereafter, the individual subscriber may access the computer-implemented subscription processing system 10, such as at step 101 and/or 102, and/or the computer-implemented subscription fulfillment system, such as at step 201 and/or 202, and/or, 301 and/or 302, and/or the computer-implemented subscription management system, such as at step 401 and/or 402, and make changes to the subscription, renew the subscription, extend the term of the subscription, lengthen the subscription, shorten the subscription, change and/or modify any of the conditions and/or information and/or instructions regarding the subscription, described herein, and/or entered and/or selected by the subscriber as described with reference to the description of the flow diagram of FIG. 6, FIG. 7A, FIG. 7B, FIG. 8A, FIG. 8B, FIG. 10A, FIG. 10B, FIG. 10C, and/or FIG. 11 and/or otherwise. The computer-implemented subscription processing system 10 will thereafter process the change to the subscription and update the subscription data and/or information accordingly.

In this manner, the individual subscriber can renew a subscription, extend the term of the subscription, lengthen a subscription, shorten a subscription, expand the scope of the subscription, reduce the scope of the subscription, terminate the subscription, alter the scope of the subscription, change the terms of the subscription, make, receive, and/or accept offers to expand and/or reduce, and/or alter the commercial and/or technical terms of the subscription, interact with the system via a retail location, and/or point-of-sale device for the purpose of receiving and/or sending elective message tags. Subscription changes may be entered and/or selected by the elective message tag subscriber, elective message tag provider, and/or elective message tag service provider in real-time and/or otherwise, via a respective communication device 30 and/or plurality of devices, and/or via any point-of-sale transaction device 40.

At any time, the individual subscriber can also access any computer-implemented subscription processing system 10 and/or any computer-implemented subscription fulfillment system 20, and computer-implemented subscription management system 50, in order to determine the subscription status and/or to change, alter and/or modify, any of the information, described herein and/or otherwise, which is related to, and/or regarding, the subscription, the fulfillment of the subscription, the status of the subscription, and/or the subscription fulfillment status of the subscription and/or the service status of the subscription.

The respective computer-implemented subscription processing system 10 and/or the computer-implemented subscription fulfillment system 20 and/or the computer-implemented subscription management system 50 will thereafter process the change to the subscription and update the subscription data and/or information accordingly.

FIGS. 7A and 7B illustrate a flow diagram of another preferred embodiment operation of the apparatus and method of the present invention in fulfilling elective message tagging subscriptions and/or servicing elective message tagging subscriptions. In the embodiment of FIGS. 7A and 7B, the apparatus allows the individual subscriber to receive the elective message tags of the messages at a retail facility, such as at a kiosk, a store, a theater, a stadium, etc., thereby allowing the individual subscriber the freedom and convenience of receiving elective message tags at any desired time and/or from any desired retail facility.

The operation of the present invention, as illustrated and described in FIGS. 7A and 7B, can typically be utilized once a subscription has been created via the method described herein with reference to FIG. 6, as well as by any other conventional subscription creating and/or initiation method.

In the preferred embodiment of FIGS. 7A and 7B, the apparatus of the present invention can also be utilized at the same time as, or in conjunction with, the creation and/or commencement of a subscription so as to provide for an immediate first elective message tag at the time, and or immediately following, the creation and/or commencement of the individual subscriber's subscription. In this manner, an individual subscriber can, for example, go to a website, such as an online retailer, request and enter into a transaction that will result in a communication and/or message, have the subscription initiated and/or created via the e-commerce enabled point-of-sale transaction device 40, and conclude the online retail transaction with the receipt of the first elective message tag pursuant to the subscription.

In another preferred embodiment, the operation of the apparatus of the present invention, as described herein with reference to the embodiment of FIG. 6, can be readily and easily modified so as to provide the individual subscriber with an elective message tag and provide for an appropriate charging, debiting, and/or crediting, of the subscription account, and/or associated financial accounts of the subscriber, as desired, if the commercial terms dictate that payment be made by the subscriber for the elective message tag.

The operation of the embodiment of FIGS. 7A and 7B commences at step 200. At step 201, the subscriber desiring to receive an elective message tag and/or tags can receive desired elective message tag and/or tags by either configuring the computer-implemented subscription fulfillment system 20 to automatically and/or dynamically execute functions on their behalf, and/or the subscriber desiring to receive an elective message tag, and/or the salesperson or checkout person at the retail facility, can request the elective message tag by accessing the computer-implemented subscription fulfillment system 20 via a respective communication device 30 and/or plurality of devices, and/or via any point-of-sale transaction device 40. Once the computer-implemented subscription fulfillment systems 20 is accessed, subscription account information is entered into either automatically or manually via the communication device 30, the point-of-sale transaction device 40, or any of the databases associated with the apparatus and/or method of the present invention 10H, 20H, 30H, 40H, and/or 50H, at step 202, by inputting same via digital information transfer, electronic information transfer, the user input device 40E, the communication device 30, and/or by scanner/reader 40B, a device and/or payment apparatus and/or payment card, and/or via a transaction apparatus utilized in conjunction with services provided by and/or with the elective message tag provider and/or the elective message tag service provider.

At step 202, any other information regarding and/or further identifying the subscription account can also be entered and/or input. At step 203, the information entered and/or input at step 202 is transmitted to, and received by, the computer-implemented subscription fulfillment system 20. At step 204, the computer-implemented subscription fulfillment system 20 will process the information and determine whether the subscription account is still active. If, at step 204, it is determined that the subscription account is not active, the computer-implemented subscription processing system 20 will, at step 205, transmit a signal to communication device 30, and/or the point-of-sale transaction device 40, to provide notification of the inactive or lapsed account.

Thereafter, operation of the present invention will cease at step 206 and the individual subscriber may thereafter, access the computer-implemented subscription processing system 10 in order to re-open and/or renew the subscription. In another preferred embodiment, the computer-implemented subscription fulfillment system 20 can transfer operation to the computer-implemented subscription processing system 10, at step 205. Thereafter, subscription account re-opening and/or renewal can occur on-line via the communication device 30, and/or point-of-sale transaction device 40, and operation can proceed to step 202 to re-enter the pertinent account information. This preferred embodiment operation can facilitate a re-opening or renewal of the subscription account in one and the same instance of receiving a message via communication device, and/or an informational and/or commercial transaction at a kiosk, and/or interaction between the individual subscriber and the salesperson or check-out person at a retail facility.

If, at step 204, it is determined that the subscription account is still active, operation will proceed to step 207 and the computer-implemented subscription fulfillment system 20 will determine if any elective message tags remain to be delivered on the subscription account. If, at step 207, it is determined that no elective message tags remain to be delivered, then operation will proceed to step 205 described above and notification of this fact will be provided to the individual subscriber via communications device 30, and/or the e-commerce point-of-sale device, and/or the e-commerce point-of-sale device, and/or the salesperson and/or checkout person via the point-of-sale transaction device 40.

Thereafter, operation of the apparatus will proceed as described above with operation either ceasing and/or the individual subscriber renewing the subscription, extending the term of the subscription, and/or purchasing additional elective message tags and/or arranging for same.

If, at step 207, it is determined that elective message tags remain to be delivered on the subscription account, then operation will proceed to step 208 and the computer-implemented subscription fulfillment system 20 will transmit a signal to the communications device 30, and/or the point-of-sale transaction device 40 authorizing the receipt of the elective message tag by the individual subscriber. In the preferred embodiment, at step 208, the point-of-sale device 40, may generate a digital, and/or printed receipt of the transaction, via the printer or output device 40J, and/or display device 40F, for the retailer for the retailer's records. In the preferred embodiment, at step 208, the point-of-sale device 40, will also generate and print a receipt of the transaction, via the printer or output device 40J, and/or display device 40F, for the individual subscriber for the individual subscriber's records.

At step 209, the computer-implemented subscription fulfillment system 20 will record the fulfillment of the elective message tag delivery and/or transaction, decrease by one the number of elective message tags remaining to be delivered on the subscription account, in the case where a predetermined amount of elective messages is being depleted, and/or will increase by one the number of elective messages delivered on the subscription account, in the case where the objective is to increase the number of delivered elective message tags to either a predetermined amount, and dynamically calculated amount, and/or an unlimited amount, and provide all record updating for the subscription account.

The computer-implemented subscription fulfillment system 20, in the preferred embodiment, at step 209, will also update any and/or pertinent subscription account records and/or information, for the subscription account, in its database 20H as well as the corresponding records and/or information for the subscription account which are stored in the database 10H of the computer-implemented subscription processing system 10 as well as the corresponding records and/or information for the subscription account which are stored in the database 50H of the computer-implemented subscription management system 50. These updates to the computer-implemented subscription processing system database 10H, and computer-implemented subscription management system database 50H, can be performed via transmitting an appropriate signal to the computer-implemented subscription processing systems 10 and/or 50 and/or via dynamically linked database methods and/or techniques, and/or via any other device, method and/or techniques known by those skilled in the art.

Thereafter, operation of the apparatus will cease at step 210.

In another preferred embodiment of the present invention, the apparatus and method of the present invention can provide for, and can perform fulfillment services for, and regarding, elective message tagging subscriptions which have flexibility regarding when elective message tags can be obtained and/or skipped while still providing the individual subscriber with the value of, and/or with the number of elective message tagging subscriptions for which the individual subscriber has contracted. In this manner, an individual subscriber who knows ahead of time that he or she may not be able to utilize elective message tags of the message at certain times, can forego obtaining same and effectively lengthen the subscription term and/or duration and/or attainment of commitment until he or she receives all elective message tags.

For example, in one embodiment of such a flexible subscription account, an individual subscriber can enter a subscription for an elective message tag to be transmitted on a weekly basis along with a short message service (SMS) message whereby he or she will receive a limited time offer of a discount on a product that can be purchased at a local retailer. If the individual subscriber should travel outside of a reasonable and/or predetermined distance from the retailer, the message can be put queued and/or saved for delivery at a later time when the subscriber is back within the geographic bounds designated by the limitation.

The amount and parameters of elective message tag flexibility can be dictated by each of the elective message tag providers, and/or entities making associated offers.

FIGS. 8A and 8B illustrate a flow diagram of another preferred embodiment method for utilizing the apparatus of the present invention wherein the present invention is utilized to fulfill elective message tagging subscriptions and/or to service elective message tagging subscriptions.

In the preferred embodiment of FIGS. 8A and 8B, the apparatus of the present invention allows the individual subscriber to receive the elective message tags on a communication device 30, and/or at a point-of-sale device 40, of which either may be located at in a digital environment, such as a website and/or virtual premise, and/or a physical environment such as a retail shop, and/or a kiosk, thereby allowing the individual subscriber the freedom and convenience of receiving elective message tags at any desired time and/or from any desired device. Further, in the embodiment of FIGS. 8A and 8B, the present invention allows the individual subscriber to receive or obtain elective message tags under a plethora of commercially available terms and/or communications means and/or modes as to provide maximum flexibility for the subscriber of elective message tags and the providers of elective message tags. In this manner, for example, an individual subscriber may delay, restrict, redirect, skip, miss, and/or otherwise alter the delivery of the elective message tag(s) and receive or obtain alternative, other, and/or future elective message tags within the constraints of their subscription agreement, and may where relevant, without forfeiting the value of the elective message tag(s).

The flexible subscription described in conjunction with the preferred embodiment of FIGS. 8A and 8B, can provide an individual subscriber with greater flexibility in receiving elective message tagging subscriptions as well as serve as an incentive to enter into a subscription in the first place. The individual subscriber can also take advantage of offers, promotions, etc., while obtaining the desired flexibility in obtaining elective message tags. An individual subscriber can, as a result, obtain and enjoy the full value and/or number of elective message tags when they are able.

It is understood, however, that flexibility can be limited. An elective message tag provider may set its own limitations and/or restrictions on the flexibility associated with the delivery of the elective message tag and/or derivative offers and/or services with which it is associated. For example, a maximum time period in which the subscriber must obtain all of his or elective message tags or forfeit the opportunity to receive same. These terms, however, can be agreed upon by the contracting parties.

The operation of the embodiment of FIGS. 8A and 8B commences at step 300. At step 301, the individual subscriber desiring to receive an elective message tag can automatically request and/or manually request the elective message tag by accessing the computer-implemented subscription fulfillment system 20 via the communications device 30 and/or the point-of-sale transaction device 40. Once the computer-implemented subscription fulfillment systems 20 is accessed, subscription information and/or subscriber information is transmitted to the computer-implemented subscription fulfillment system 20.

At step 302, any other information regarding and/or further identifying the subscription account and/or request for an elective message tag can also be entered via communications device input device 30D, and/or point-of-sale device 40E, and/or by swiping a respective account card, smart card, payment card, ticket, computer chip enabled device, etc., and/or in the scanner/reader 40B.

At step 303, the information entered and/or input at step 302 is transmitted to, and received by, the computer-implemented subscription fulfillment system 20. At step 304, the computer-implemented subscription fulfillment system 20 will process the information and determine whether the subscription account is still active. If, at step 304, it is determined that the subscription account is not active, the computer-implemented subscription processing system 20 will, at step 305, transmit a signal to the communications device 30, and/or point-of-sale transaction device 40, to provide notification of the inactive or lapsed account.

Thereafter, operation of the present invention will cease at step 306 and the individual subscriber may thereafter, access the computer-implemented subscription processing system 10 in order to re-open and/or renew the subscription. In another preferred embodiment, the computer-implemented subscription fulfillment system 20 can transfer operation to the computer-implemented subscription processing system 10, at step 305. Thereafter, subscription account re-opening and/or renewal can occur on-line via the communications device 30 and/or the point-of-sale transaction device 40 and operation can proceed to step 302 to re-enter the pertinent account information. By example, this preferred embodiment operation can facilitate a re-opening or renewal of the subscription account in one and the same interaction between the individual subscriber and an e-commerce point-of-sale transaction on a website, and/or an in-person transaction at a retail facility.

If, at step 304, it is determined that the subscription account is still active, operation will proceed to step 307A and the computer-implemented subscription fulfillment system 20 will determine if any elective message tags remain to be delivered on the subscription account. If, at step 307A, it is determined that no elective message tags remain to be delivered, then operation will proceed to step 305 described above and notification of this fact will be provided to the individual subscriber via communication device 30, and/or the e-commerce point-of-sale device, and/or the e-commerce point-of-sale device, and/or the salesperson and/or checkout person via the point-of-sale transaction device 40.

Thereafter, operation of the apparatus will proceed as described above with operation either ceasing and/or the individual subscriber renewing the subscription, extending the term of the subscription, and/or subscribing to additional elective message tags and/or arranging for same.

If, at step 307A, it is determined that elective message tags remain to be delivered on the subscription account, then operation will proceed to step 307B and the computer-implemented subscription fulfillment system 20 will determine whether subscription limitations have been enacted and/or subscription limitations have been reached. If, at step 307B, it is determined that whether subscription limitations have been enacted and/or subscription limitations have been reached, then operation will proceed to step 305 described above and notification of this fact will be provided to the individual subscriber via communications device 30, and/or the e-commerce point-of-sale device, and/or the salesperson and/or checkout person via the point-of-sale transaction device 40. Thereafter, operation of the apparatus will proceed as described above with operation either ceasing and/or the individual subscriber renewing the subscription, extending the term of the subscription, and/or purchasing additional elective message tags and/or arranging for same.

If, at step 307B, it is determined that no relevant subscription limitations have been enacted and/or that no subscription limitations have been reached, then operation will proceed to step 308 and the computer-implemented subscription fulfillment system 20 will transmit an elective message tag, or a signal to authorize, display, print, and/or by some other means produce, an elective message tag, to the communications device 30, and/or the point-of-sale transaction device 40. In the preferred embodiment, at step 308, the communications device 30, and/or the point-of-sale device 40, will execute all relevant operations associated with the elective message tag, and may generate and display and/or print a record, ticket, receipt, etc., of the transaction, via the output devices 30I and/or 40J, and/or display device 30E and/or 40F.

At step 309, the computer-implemented subscription fulfillment system 20 will record the fulfillment of the elective message tag delivery and/or transaction, decrease by one the number of elective message tags remaining to be delivered on the subscription account, and/or increase by one the number of elective message tags delivered on the subscription, and/or note details of the transaction and/or associated transactions, and/or information collected during the elective message tag deliver, and/or related transaction, and provide all record updating for the subscription account. The computer-implemented subscription fulfillment system 20, in the preferred embodiment, at step 309, will also update any and/or pertinent subscription account records and/or information, for the subscription account, in its database 20H as well as the corresponding records and/or information for the subscription account which are stored in the database 10H of the computer-implemented subscription processing system 10 as well as the corresponding records and/or information for the subscription account which are stored in the database 50H of the computer-implemented subscription management system 50.

The above-described updates to the computer-implemented subscription processing system database 10H, the computer-implemented subscription fulfillment system database 20H, and the computer-implemented subscription management system database 50H, can be performed via transmitting an appropriate signal to the computer-implemented subscription processing system 10, subscription fulfillment system 20, subscription management system 50, and/or via dynamically linked database methods and/or techniques, and/or via any other device, method and/or techniques known by those skilled in the art.

Thereafter, operation of the apparatus will cease at step 310.

In any and/or all of the embodiments described herein, the computer-implemented subscription processing system 10 and/or the computer-implemented subscription fulfillment system 20, and/or the computer-implemented subscription management system 50 can provide processing for any number and/or type of elective message tagging subscriptions. In this manner, the computer-implemented subscription processing system 10 and/or the computer-implemented subscription fulfillment system 20 and/or the computer-implemented subscription management system 50 can administer, manage, service, and/or provide processing, for any number and/or types of elective message tags and/or elective message tagging subscriptions.

In any and/or all of the embodiments described herein, the apparatus and method of the present invention can provide for elective message tagging subscriptions which can be initiated and/or created and/or communicated and/or be operated upon via any communication device 30 and/or any point-of-sale transaction device 40. In any and/or all of the embodiments described herein, the elective message tagging subscriptions can be delivered and/or serviced by any communications service, communications network, computer service, computer network, computer-implemented communications and/or computing environment, premise, vehicle, being, kiosk, retail and/or other facility. In this manner, for example, an individual subscriber may initiate a subscription for a message from any location and receive the elective message tags of the subscription from any digital environment and/or physical retail facility which is a participating facility and/or a facility which utilizes the present invention and/or which utilizes an enabled communications device 30, and/or point-of-sale transaction device 40, thereby providing flexibility in the elective message tag receiving location.

In any and/or all of the embodiments described herein, the individual subscriber or an agent and/or other third party intermediary, can access the computer-implemented subscription processing system 10 and/or the computer-implemented subscription fulfillment system 20 and/or the computer-implemented subscription management system 50, via the communication device 30 and/or via the point-of-sale transaction device 40 so as to ascertain the status of an individual subscription such as, but not limited to, whether the subscription is active or inactive, and/or the fulfillment status of the subscription, such as, but not limited to, the number of elective message tags sent, and/or remaining on order, and/or any and all analytics associated with the elective message tags and/or elective message tag subscription.

In any and/or all of the embodiments described herein, the elective message tag provider, and/or elective message tag service provider, and/or affiliated third party service providers, and/or an agent and/or other third party intermediary, can access the computer-implemented subscription processing system 10 and/or the computer-implemented subscription fulfillment system 20 and/or the computer-implemented subscription management system 50, via the communication device 30 and/or via the point-of-sale transaction device 40 so as to ascertain the status of a group of subscriptions, and/or a subset of a group of subscriptions, and/or an individual subscription, and/or a subset of an individual subscription such as, but not limited to, whether the subscription(s) is active or inactive, and/or the fulfillment status of the subscription(s), such as, but not limited to, the number of elective message tags sent, and/or remaining on order(s), and/or any and all analytics associated with the elective message tags and/or elective message tag subscriptions.

In any and/or all of the embodiments described herein, the computer-implemented subscription processing system 10 and/or the computer-implemented subscription fulfillment system 20 and/or the computer-implemented subscription management system 50 can also notify individual subscribers, via any means, method and/or manner of communication, via the communication device 30 and/or the point-of-sale transaction device 40, of available elective message tags, and/or promotions, and/or offers, and/or specials, and/or exclusives of elective message tags, and/or products and/or services associated with elective message tags, alerts, renewal notices, extension notices, termination notices, subscription creation and/or initiation notices, shipment to and/or arrival of goods and services associated with the elective message tag services, the subscription elective message tag, goods and/or services at a respective retail facility and/or other facility associated with the elective message tags, and/or of any other information which may be of interest to an individual subscriber.

In any and/or all of the embodiments described herein, the apparatus and method of the present invention can be utilized as a subscription clearinghouse, to match individual elective message tag subscribers to elective message tag providers, and/or offers from elective message tag providers, and/or goods and/or services associated with elective message tags, wherein information regarding any number of, and types of such expressions of interest and/or offers can be stored in the database 10H of the computer-implemented subscription processing system 10 and/or the database 20H of the computer-implemented subscription fulfillment system 20 and/or the database 50H of the computer-implemented subscription management system 50. Any individual elective message tag subscriber, elective message tag provider, elective message tag service provider, and/or associated providers of goods and/or services, can access the respective computer-implemented subscription processing system 10 and/or computer-implemented subscription fulfillment system 20 and/or the computer-implemented subscription management system 50, and search for a desired elective message tag(s), offers, inquiries, elective message tag subscribers, elective message tag providers, and/or elective message tag service providers. Any of these entities may then apply to, inquire, offer, counter-offer, enroll in, and/or transact for the elective message tag services and/or associated goods and/or services described herein.

In any and/or all of the embodiments described herein, an individual subscriber can input a request and/or an order for an elective message tag and/or elective message tagging services, with information regarding the order being stored in the database 10H of the computer-implemented subscription processing system 10, and/or the database 20H of the computer-implemented subscription fulfillment system 20, and/or the database 50H of the computer-implemented subscription management system 50. The computer-implemented subscription processing system 10 and/or the computer-implemented subscription fulfillment system 20 and/or the computer-implemented management system 50 can thereafter process the order or order and notify the subscriber via the communication device 30 and/or the point-of-sale transaction device 40 if and when the ordered and/or requested elective message tag and/or elective message service is available. The individual subscriber may be notified via any appropriate and/or available digital, electronic, and/or physical, and or other communications means, method and/or technique.

In any and/or all of the embodiments described herein, any of the computer-implemented subscription processing system(s) 10, the computer-implemented subscription fulfillment system(s) 20, the computer-implemented subscription management system(s) 50, the communication device(s) 30, and/or the point-of-sale transaction device(s) 40, can be programmed for automatic operation, self-activation, and/or programmed operation. The computer-implemented subscription processing system 10 and/or the computer-implemented subscription fulfillment system 20 and/or the computer-implemented subscription management system 50, can be programmed to automatically generate and/or to transmit messages and/or notices to any of the individual subscribers, retailers, goods and/or services providers, etc., regarding elective message tags, elective message tagging subscriptions, subscription fulfillment, the availability of elective message tags, offers related to elective message tagging subscriptions, availability of elective message tags and/or goods and/or services which are the associated with an elective message tagging subscription.

In any and/or all of the embodiments described herein, intelligent agents, software agents, and/or mobile agents, and/or computer code, and/or computer applications, and/or applets, and/or scripts, can be utilized so as to act on behalf of any of the parties and/or any of the respective computers and/or devices described herein. Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

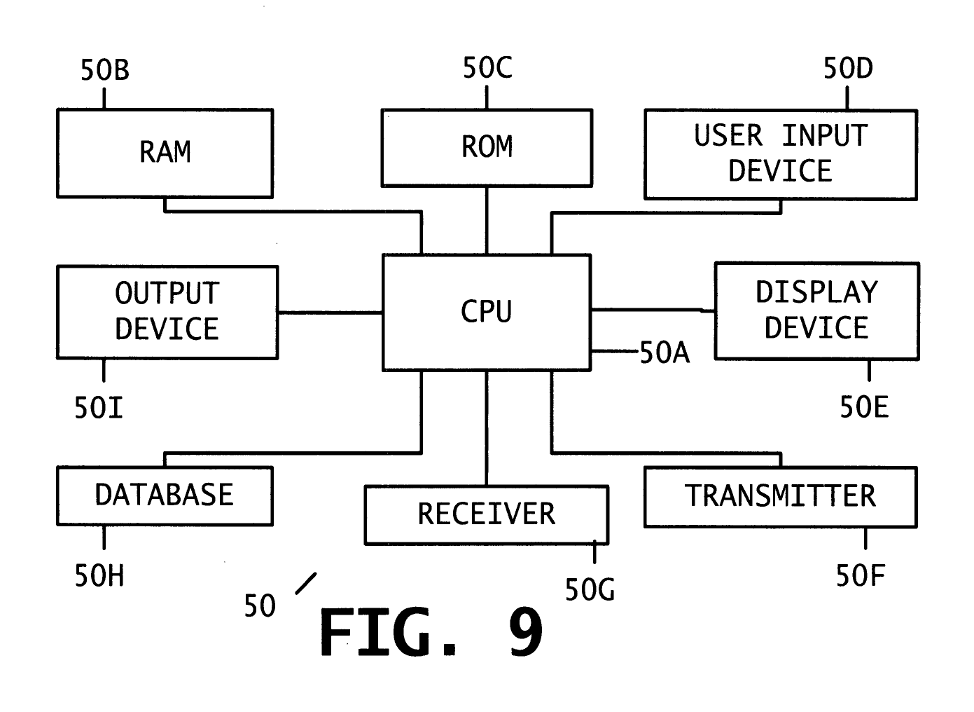

FIG. 9 illustrates the computer-implemented subscription management system 50, in block diagram form. The computer-implemented subscription management system 50, in the preferred embodiment, is a network computer or computer system which is utilized as a computer-implemented subscription management system such as an server, servers in a datacenter, a web server, an Internet server computer, an e-commerce server computer, a communications server, a database server, a mobile computer, and/or any similar computer or computer system.

The computer-implemented subscription management system 50 can also be any other computer or computer system which can be utilized in any computing and/or communication network. In the preferred embodiment, the computer-implemented subscription management system 50 includes a central processing unit or CPU 50A, which in the preferred embodiment, is a microprocessor. The CPU 50A may also be a microcomputer, a minicomputer, a macro-computer, a computer on a chip, a nano computer, a synthetic computer, a biological computer, a multi-core computer, a multi-component computer, a physical computer, a virtualized computer, a single computer, a combination of computers, a computer system, a networked computer system, and/or a mainframe computer, depending upon the application.

The computer-implemented subscription management system 50 also includes a random access memory device(s) 50B (RAM) and a read only memory device(s) 50C (ROM), each of which is connected to the CPU 50A, a user input device 50D, for entering data and/or commands into the computer-implemented subscription management system 50, which includes any one or more of a key pad, a keyboard, a scanner, a touch pad, a signature pad, a card reader, a magnetic strip card reader, a biometric scanner, a subscriber identity module reader, a chip reader, a signal scanner, a camera, a video camera, a microphone, a graphic image and/or video signal generator, an audio signal and/or audio image generator, a user pointing device, such as, for example, a mouse, a touch pad, and/or an audio input device and/or a video input device, etc., if desired, which input device(s) is also connected to the CPU 50A.

The computer-implemented subscription management system 50 also includes a display device 50E for displaying data and/or information to a user or operator.

The computer-implemented subscription management system 50 also includes a transmitter(s) 50F, for transmitting signals and/or data and/or information to any one or more of the computer-implemented subscription management system(s) 50, the computer-implemented subscription fulfillment system(s) 20, the computer-implemented subscription management system 50, the point-of-sale transaction devices 40, and the communication devices 30, which may be utilized in conjunction with the present invention. The computer-implemented subscription management system 50 also includes a receiver 50G, for receiving signals and/or data and/or information from to any one or more of the computer-implemented subscription management system(s) 50, the computer-implemented subscription fulfillment system(s) 20, the computer-implemented subscription management system 50, the point-of-sale transaction devices 40, and the communication devices 30, which may be utilized in conjunction with the present invention.

The computer-implemented subscription management system 50 also includes a database 50H. The database can include data and/or information regarding elective message tag provider, or entity which provides data and/or information and/or functionality which may be either attached to, embedded in, and/or associated with the elective message tags, for which subscriptions are provided and/or available via the apparatus of the present invention. The database 50H can also include data and/or information regarding the services and/or products that may be provided in association with, and/or derived from, the elective message tagging services.

The database 50H can also include data and/or information regarding the subscriber, including all histories of usage, commercial terms, payments, technical, and/or communications usage in conjunction with the elective messaging tagging service. The database 50H can also include all data and/or information regarding the subscriber including all communications account information, financial account information, and a multitude of profiling information including, but not limited to, preferences, demographics, activity streams, behavioral targeting, data logging, digital footprint, lifelog, lifestreaming, profiling, runtime intelligence, social translucence, trace, trace evidence, genetic sequencing, psychographics, data represented in Attention Profiling Mark-up Language, subject and/or interest item information, communications, browsing histories, browsing patterns, documents, files, computational usage statistics, communications usage statistics, content created, content viewed, heard and/or read, content downloaded, applications used and/or downloaded, search queries, search results, click-through on search results, digital traces, activities, behaviors, login and logouts, visit of pages, documents accesses, items created, affiliation to groups, attention, social group, repetition, location, reputation, financial activities, investing activities, income data, spending data, consumption data, tax data, credit data, credit history data, reputational data, media related data, sensor discovered data, sensor recorded data, digital footprints, digital finger prints, life streams, social media linkages, social media activities, communications activities, computing activities, personal status, medical information, health information, personally identifiable information, volunteered information, collected information, rumored information, non-volunteered information, information capable of being stored in log files, information capable of being stored locally and/or or in a private and/or public cloud computing environment, information capable of being stored in databases, mined data, as well as the analytics associated with the aforementioned data and/or information, with respect to the services provided related to elective message tagging.

The database 50H can also include data and/or information regarding the services provided by the elective message tagging service provider, and/or affiliated service providers, including services previously offered, currently offered, and/or prospectively offered, content, communications, and/or commercial information regarding message tags including, but not limited to, data received by and/or from the elective message tag subscriber, data received by and/or from the elective message tag provider, and/or data generated by the elective message tag service provider through activities associated with the providing of elective message tagging services, as well as the analytics associated with any of the aforementioned data and/or information, with respect to the services provided related to elective message tagging.

The database 50H can also include data and/or information regarding the actual tag tags provided and/or offered by the elective message tag providers, including, but not limited to data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, and/or an embodiment of information, and/or an embodiment of control functionality, as well as the analytics associated with any of the aforementioned data and/or information, with respect to the services provided related to elective message tagging.

The database 50H also includes information regarding the elective message tagging subscriptions which each subscriber has subscribed to, type of subscription, subscription length or duration, subscription cost, subscription renewals, subscription extensions, elective message tags received and/or offered, status of subscription agreement, remaining subscription agreement commitments, and/or any other relevant information regarding the respective elective message tagging subscriptions and/or the fulfillment of the respective elective message tagging subscriptions.

The database 50H also includes information regarding the date the respective elective message tagging subscriptions were ordered, became effective, date of the start of the subscription, date of subscription termination, retailer and/or subscription origination agent from who the subscription originated, and the retailer, goods provider, and/or services provider, subscription service entity, and/or subscription fulfillment entity and/or agent from whom the subscriber will obtain the respective elective message tags, and/or elective message tagging services, which are be the subject of the elective message tagging subscriptions. The database 50H also includes information regarding customer service agents and/or entities for providing customer services for, and/or regarding, any of the respective elective message tagging subscriptions.

The database 50H may also contain any other information which may be relevant, pertinent, useful, and/or desired, for facilitating the operation of the apparatus and method of the present invention as described herein and/or as related thereto.

The database 5014, in the preferred embodiment, is a database which may include individual databases or collections of databases, with each database being designated to store any and all of the data and/or information described herein. Applicant hereby incorporates by reference herein the teachings of Basic Business Statistics Concepts and Applications, Mark L. Berenson and David M. Levine, 6.sup.th Edition, Prentice Hall 1996.

The database 50H, or collection of databases, may be updated by each of the respective individual subscribers, computer-implemented subscription management system operator or administrator, computer-implemented subscription fulfillment system operator or administrator, computer-implemented subscription management system operator or administrator, point-of-sale transaction device operator, communication device operator or administrator, via any of their respective computers and/or devices, and/or by any other third party, in real-time, and/or via dynamically linked database management techniques.

The data and/or information stored in the database 50H can also be updated by external sources. The database 50H will contain any and all information deemed necessary and/or desirable for providing all of the processing and/or services and/or functions described herein. Applicant hereby incorporates by reference herein the subject matter of Fundamentals of Database Systems, by Ramez Elmasri and Shamkant B. Navathe, 2.sup.nd Ed., Addison-Wesley Publishing Company, 1994.

The database 50H can also include any contact information for any of the subscribers, subscription providers, subscription fulfillment providers, retailers, point-of-sale entities, etc., such as, but not limited to, names, addresses, telephone numbers, fax numbers, e-mail addresses, URL's, websites, hyper-links, XML data, personal identification information, business identification information, SIC codes, links to third-party and/or government sponsored identification information, and/or any other contact information, for the respective party. The database 50H also includes any of the above-described contact information regarding any intermediaries, third parties, agents, and/or brokers, who utilize the apparatus of the present invention.

The database 50H can also include any other data and/or information needed and/or desired for facilitating the functions and operation of the present invention as described herein.

With reference once again to FIG. 9, the computer-implemented subscription management system 50 also includes an output device 50I such as a printer, a modem, a fax/modem, or other output device, for providing data and/or information to the operator or user of the computer-implemented subscription management system 50 or to a third party or third party entity.

FIGS. 10A, 10B, and 10C illustrate a flow diagram of another preferred embodiment method for utilizing the apparatus of the present invention wherein the present invention is utilized to manage elective message tagging subscriptions and/or to service elective message tagging subscriptions.

In the preferred embodiment of FIGS. 10A, 10B, and 10C, the apparatus of the present invention allows the individual subscriber to receive the elective message tags on a communication device 30, and/or at a point-of-sale device 40, of which either may be located at in a digital environment, such as a website and/or virtual premise, and/or a physical environment such as a retail shop, and/or a kiosk, thereby allowing the individual subscriber the freedom and convenience of receiving elective message tags at any desired time and/or from any desired device. Further, in the embodiment of FIGS. 10A, 10B, and 10C, the present invention allows the individual subscriber to receive or obtain elective message tags under a plethora of commercially available terms and/or communications means and/or modes as to provide maximum flexibility for the subscriber of elective message tags and the providers of elective message tags. In this manner, for example, an individual subscriber may delay, restrict, redirect, skip, miss, and/or otherwise alter the delivery of the elective message tag(s) and receive or obtain alternative, other, and/or future elective message tags within the constraints of their subscription agreement, and may where relevant, without forfeiting the value of the elective message tag(s).

The flexible subscription described in conjunction with the preferred embodiment of FIGS. 10A, 10B, and 10C, can provide an individual subscriber with greater flexibility in receiving elective message tagging subscriptions as well as serve as an incentive to enter into a subscription in the first place. The individual subscriber can also take advantage of offers, promotions, etc., while obtaining the desired flexibility in obtaining elective message tags. An individual subscriber can, as a result, obtain and enjoy the full value and/or number of elective message tags when they are able.

It is understood, however, that flexibility can be limited. An elective message tag provider may set its own limitations and/or restrictions on the flexibility associated with the delivery of the elective message tag and/or derivative offers and/or services with which it is associated. For example, a maximum time period in which the subscriber must obtain all of his or elective message tags or forfeit the opportunity to receive same. These terms, however, can be agreed upon by the contracting parties.

The operation of the embodiment of FIGS. 10A, 10B, and 10C commences at step 400. At step 401, the individual subscriber desiring to have management functions executed related to their subscription for elective message tagging and/or derivative services to be executed related to their subscription for elective message tagging can automatically request and/or manually request the management functions related to their subscription for elective message tagging and/or derivative services related to their subscription for elective message tagging by accessing the computer-implemented subscription management system 50 via the communications device 30 and/or the point-of-sale transaction device 40. Once the computer-implemented subscription management system 50 is accessed, requests and/or commands related to fulfillment of elective message tags and/or subscription information and/or subscriber information is transmitted to the computer-implemented subscription fulfillment system 20.

At step 402, any other information regarding and/or further identifying the subscription account and/or request for an elective message tag can also be entered via communications device input device 30D, and/or point-of-sale device 40E, and/or by swiping a respective account card, smart card, payment card, ticket, computer chip enabled device, etc., and/or in the scanner/reader 40B.

At step 403, the information entered and/or input at step 402 is transmitted to, and received by, the computer-implemented subscription management system 50. At step 404, the computer-implemented subscription management system 50 will process the information and determine whether the subscription account is still active. If, at step 404, it is determined that the subscription account is not active, the computer-implemented subscription processing system 20 will, at step 405, transmit a signal to the communications device 30, and/or point-of-sale transaction device 40, to provide notification of the inactive or lapsed account.

Thereafter, operation of the present invention will cease at step 406 and the individual subscriber may thereafter, access the computer-implemented subscription processing system 10 in order to re-open and/or renew the subscription. In another preferred embodiment, the computer-implemented subscription management system 50 can transfer operation to the computer-implemented subscription processing system 10, at step 405. Thereafter, subscription account re-opening and/or renewal can occur on-line via the communications device 30 and/or the point-of-sale transaction device 40 and operation can proceed to step 402 to re-enter the pertinent account information. By example, this preferred embodiment operation can facilitate a re-opening or renewal of the subscription account in one and the same interaction between the individual subscriber and an e-commerce point-of-sale transaction on a website, and/or an in-person transaction at a retail facility.

If, at step 404, it is determined that the subscription account is still active, operation will proceed to step 407A and the computer-implemented subscription management system 50 will determine if management functions and/or derivative services remain to be executed. If, at step 407A, it is determined that no management functions and/or derivative services remain to be executed, then operation will proceed to step 405 described above and notification of this fact will be provided to the individual subscriber via communication device 30, and/or the e-commerce point-of-sale device, and/or the e-commerce point-of-sale device, and/or the salesperson and/or checkout person via the point-of-sale transaction device 40.

Thereafter, operation of the apparatus will proceed as described above with operation either ceasing and/or the individual subscriber renewing the subscription, extending the term of the subscription, and/or subscribing to additional elective message tags and/or arranging for same.

If, at step 407A, if it is determined that management functions and/or derivative services remain to be executed, then operation will proceed to step 407B and the computer-implemented subscription management system 50 will determine whether or not the management functions and/or derivative services are functions and/or operations capable of being executed by the computer-implemented subscription management system. If, at step 407B, it is determined that the management functions and/or derivative services are functions of the computer-implemented subscription management system, then operation will proceed to step 408 and the computer-implemented subscription management system 50 will execute a management function associated with the elective message tagging service, and/or where in the computer-implemented subscription management system 50 may also transmit an elective message tag, or a signal to authorize, display, print, and/or by some other means produce, an elective message tag, to the communications device 30, and/or the point-of-sale transaction device 40. In the preferred embodiment, at step 408, the communications device 30, and/or the point-of-sale device 40, will execute all relevant operations associated with the elective message tag, and may generate and display and/or print a record, ticket, receipt, etc., of the transaction, via the output devices 30I and/or 40J, and/or display device 30E and/or 40F.

If, at step 407B, it is determined that the management functions and/or derivative services are not functions and/or operations capable of being executed by the computer-implemented subscription management system, then operation will proceed to step 407C. At step 407C the computer-implemented subscription management system will determine if there are third-party derivative services and/or functions available to receive a hand-over of the request. If, at step 407C, it is determined that the management functions and/or derivative services from a third-party are available to execute the requested operation and/or function then the operation will then proceed to step 410 and the computer-implemented subscription management system 50 will execute the hand-over to the third-party derivative service and/or function associated with the elective message tagging service, and/or where in the computer-implemented subscription management system 50 may also transmit an elective message tag, or a signal to authorize, display, print, and/or by some other means produce, an elective message tag, to the communications device 30, and/or the point-of-sale transaction device 40. In the preferred embodiment, at step 410, the communications device 30, and/or the point-of-sale device 40, will execute all relevant operations associated with the elective message tag, and may generate and display and/or print a record, ticket, receipt, etc., of the transaction, via the output devices 30I and/or 40J, and/or display device 30E and/or 40F. If, at step 407C, it is determined that no third-party derivative services and/or functions are available to receive a hand-over of the request, then operation will proceed to step 405 described above and notification of this fact will be provided to the individual subscriber via communication device 30, and/or the e-commerce point-of-sale device, and/or the e-commerce point-of-sale device, and/or the salesperson and/or checkout person via the point-of-sale transaction device 40.

Thereafter, operation of the apparatus will proceed as described above with operation either ceasing and/or the individual subscriber renewing the subscription, extending the term of the subscription, and/or subscribing to additional elective message tags and/or arranging for same.

At step 409, the computer-implemented subscription management system 50 will record the management of the elective message tag delivery and/or transaction, decrease by one the number of elective message tags remaining to be delivered on the subscription account, and/or increase by one the number of elective message tags delivered on the subscription, and/or note details of the transaction and/or associated transactions, and/or information collected during the elective message tag deliver, and/or related transaction, and provide all record updating for the subscription account. The computer-implemented subscription management system 50, in the preferred embodiment, at step 409, will also update any and/or pertinent subscription account records and/or information, for the subscription account, in its database 50H as well as the corresponding records and/or information for the subscription account which are stored in the database 10H of the computer-implemented subscription processing system 10 as well as the corresponding records and/or information for the subscription account which are stored in the database 20H of the computer-implemented subscription fulfillment system 20.

The above-described updates to the computer-implemented subscription processing system database 10H, the computer-implemented subscription fulfillment system database 20H, and the computer-implemented subscription management system database 50H, can be performed via transmitting an appropriate signal to the computer-implemented subscription processing system 10, subscription fulfillment system 20, subscription management system 50, and/or via dynamically linked database methods and/or techniques, and/or via any other device, method and/or techniques known by those skilled in the art.

Thereafter, operation of the apparatus will cease at step 406.

FIG. 11 illustrates a flow diagram of another preferred embodiment method for utilizing the apparatus of the present invention wherein the present invention is utilized to fulfill services for an elective message tag.

In the preferred embodiment of FIG. 11, the apparatus of the present invention allows the individual subscriber to receive the elective message tags on a communication device 30, and/or at a point-of-sale device 40, of which either may be located at in a digital environment, such as a website and/or virtual premise, and/or a physical environment such as a retail shop, and/or a kiosk, thereby allowing the individual subscriber the freedom and convenience of receiving elective message tags at any desired time and/or from any desired device. Further, in the embodiment of FIG. 11, the present invention allows the individual subscriber to receive or obtain elective message tags under a plethora of commercially available terms and/or communications means and/or modes as to provide maximum flexibility for the subscriber of elective message tags and the providers of elective message tags. In this manner, for example, an individual subscriber may delay, restrict, redirect, skip, miss, and/or otherwise alter the delivery of the elective message tag(s) and receive or obtain alternative, other, and/or future elective message tags within the constraints of their subscription agreement, and may where relevant, without forfeiting the value of the elective message tag(s).

The flexible subscription described in conjunction with the preferred embodiment of FIG. 11, can provide an individual subscriber with greater flexibility in receiving elective message tagging subscriptions as well as serve as an incentive to enter into a subscription in the first place. The individual subscriber can also take advantage of offers, promotions, etc., while obtaining the desired flexibility in obtaining elective message tags. An individual subscriber can, as a result, obtain and enjoy the full value and/or number of elective message tags when they are able.

It is understood, however, that flexibility can be limited. An elective message tag provider may set its own limitations and/or restrictions on the flexibility associated with the delivery of the elective message tag and/or derivative offers and/or services with which it is associated. For example, a maximum time period in which the subscriber must obtain all of his or elective message tags or forfeit the opportunity to receive same. These terms, however, can be agreed upon by the contracting parties.

The operation of the embodiment of FIG. 11 commences at step 500. At step 501, the computer-implemented elective message processing system 10, and/or the computer-implemented elective message tag fulfillment system 20, and/or the computer-implemented elective message tag management system 50, receives a request to transmit an elective message tag via the communications device 30 and/or the point-of-sale transaction device 40, and/or the computer-implemented elective message processing system 10, and/or the computer-implemented elective message tag fulfillment system 20, and/or the computer-implemented elective message tag management system 50.

At step 502, the elective message tag is placed in queue, and/or may be either manually and/or automatically prioritized, and/or de-prioritized, and/or reprioritized based upon parameters set by the elective message tag subscriber, the elective message tag provider, the elective message tag service provider, and/or any other service providers of affiliated elective message tagging services.

At step 503, the elective message tag is attached to the second communication. The commercial and/or technical terms governing the attachment may be set by any one or more of the parties to the elective message tag relationship and/or delivery and/or communication.

At step 504, the elective message tag and the second communication are transmitted to and received by the communications device 30, and/or the point-of-sale transaction device 40. In another preferred embodiment, one or more of the elective message tag and the second communication may already be located and/or generated and/or stored at the communications device 30, and/or the point-of-sale transaction device 40. In yet another preferred embodiment, a signal authorizing, de-authorizing, reauthorizing, authenticating, terminating, and/or otherwise signaling, and/or controlling, the supply, and/or generation, and/or communication, and/or display of the elective message tag along with the second communication. At step 505, the elective message tag and/or the elective message tag with the second communication are displayed and/or printed via the output devices 30I and/or 40J, and/or display device 30E and/or 40F. Step 505 may or may not be required in every use case, where not, the operation proceeds directly to step 506.

At step 506, the communications device 30, and/or the point-of-sale transaction device 40, and/or the computer-implemented elective message processing system 10, and/or the computer-implemented elective message tag fulfillment system 20, and/or the computer-implemented elective message tag management system 50, will record the management of the elective message tag delivery and/or transaction, decrease by one the number of elective message tags remaining to be delivered on the subscription account, and/or increase by one the number of elective message tags delivered on the subscription, and/or note details of the transaction and/or associated transactions, and/or information collected during the elective message tag deliver, and/or related transaction, and provide all record updating for the subscription account. The computer-implemented subscription management system 50, in the preferred embodiment, at step 506, will also update any and/or pertinent subscription account records and/or information, for the subscription account, in its database 50H as well as the corresponding records and/or information for the subscription account which are stored in the database 10H of the computer-implemented subscription processing system 10 as well as the corresponding records and/or information for the subscription account which are stored in the database 20H of the computer-implemented subscription fulfillment system 20, the database 30H of the communications device 30, and/or the database 401 of the point-of-sale transaction device 40.

The above-described updates to the computer-implemented subscription processing system database 10H, the computer-implemented subscription fulfillment system database 20H, and the computer-implemented subscription management system database 50H, the communications device system database 30H, and/or the point-of-sale system database 40I, can be performed via transmitting an appropriate signal to the computer-implemented subscription processing system 10, subscription fulfillment system 20, subscription management system 50, the communications device 30, and the point-of-sale device 40, and/or via dynamically linked database methods and/or techniques, and/or via any other device, method and/or techniques known by those skilled in the art.

Thereafter, operation of the apparatus will cease at step 507.

In any and/or all of the embodiments described herein, the computer-implemented subscription processing system 10, and/or the computer-implemented subscription fulfillment system 20, and/or the computer-implemented subscription management system 50 can provide processing for any number and/or type of elective message tagging subscriptions. In this manner, the computer-implemented subscription processing system 10, and/or the computer-implemented subscription fulfillment system 20, and/or the computer-implemented subscription management system 50, and/or the computer-implemented subscription management system can administer, manage, service, and/or provide processing, for any number and/or types of elective message tags and/or elective message tagging subscriptions.

In any and/or all of the embodiments described herein, the apparatus and method of the present invention can provide for elective message tagging subscriptions which can be initiated and/or created and/or communicated and/or be operated upon via any communication device 30 and/or any point-of-sale transaction device 40. In any and/or all of the embodiments described herein, the elective message tagging subscriptions can be delivered and/or serviced by any communications service, communications network, computer service, computer network, computer-implemented communications and/or computing environment, premise, vehicle, being, kiosk, retail and/or other facility. In this manner, for example, an individual subscriber may initiate a subscription for a message from any location and receive the elective message tags of the subscription from any digital environment and/or physical retail facility which is a participating facility and/or a facility which utilizes the present invention and/or which utilizes an enabled communications device 30, and/or point-of-sale transaction device 40, thereby providing flexibility in the elective message tag receiving location.

In any and/or all of the embodiments described herein, the individual subscriber or an agent and/or other third party intermediary, can access the computer-implemented subscription processing system 10, and/or the computer-implemented subscription fulfillment system 20, and/or the computer-implemented subscription management system 50, via the communication device 30 and/or via the point-of-sale transaction device 40 so as to ascertain the status of an individual subscription such as, but not limited to, whether the subscription is active or inactive, and/or the management status of the subscription, such as, but not limited to, the number of elective message tags sent, and/or remaining on order, and/or any and all analytics associated with the elective message tags and/or elective message tag subscription.

In any and/or all of the embodiments described herein, the elective message tag provider, and/or elective message tag service provider, and/or affiliated third party service providers, and/or an agent and/or other third party intermediary, can access the computer-implemented subscription processing system 10, and/or the computer-implemented subscription fulfillment system 20, and/or the computer-implemented subscription management system 50, and/or the computer-implemented subscription management system 50, via the communication device 30 and/or via the point-of-sale transaction device 40 so as to ascertain the status of a group of subscriptions, and/or a subset of a group of subscriptions, and/or an individual subscription, and/or a subset of an individual subscription such as, but not limited to, whether the subscription(s) is active or inactive, and/or the management status of the subscription(s), such as, but not limited to, the number of elective message tags sent, and/or remaining on order(s), and/or any and all analytics associated with the elective message tags and/or elective message tag subscriptions.

In any and/or all of the embodiments described herein, the computer-implemented subscription processing system 10, and/or the computer-implemented subscription fulfillment system 20, and/or the computer-implemented subscription management system 50, can also notify individual subscribers, via any means, method and/or manner of communication, via the communication device 30 and/or the point-of-sale transaction device 40, of available elective message tags, and/or promotions, and/or offers, and/or specials, and/or exclusives of elective message tags, and/or products and/or services associated with elective message tags, alerts, renewal notices, extension notices, termination notices, subscription creation and/or initiation notices, shipment to and/or arrival of goods and services associated with the elective message tag services, the subscription elective message tag, goods and/or services at a respective retail facility and/or other facility associated with the elective message tags, and/or of any other information which may be of interest to an individual subscriber.

In any and/or all of the embodiments described herein, the apparatus and method of the present invention can be utilized as a subscription clearinghouse, to match individual elective message tag subscribers to elective message tag providers, and/or offers from elective message tag providers, and/or goods and/or services associated with elective message tags, wherein information regarding any number of, and types of such expressions of interest and/or offers can be stored in the database 10H of the computer-implemented subscription processing system 10 and/or the database 20H of the computer-implemented subscription fulfillment system 20 and/or the database 50H of the computer-implemented subscription management system 50. Any individual elective message tag subscriber, elective message tag provider, elective message tag service provider, and/or associated providers of goods and/or services, can access the respective the computer-implemented subscription processing system 10, and/or the computer-implemented subscription fulfillment system 20, and/or the computer-implemented subscription management system 50, and search for a desired elective message tag(s), offers, inquiries, elective message tag subscribers, elective message tag providers, and/or elective message tag service providers. Any of these entities may then apply to, inquire, offer, counter-offer, enroll in, and/or transact for the elective message tag services and/or associated goods and/or services described herein.

In any and/or all of the embodiments described herein, an individual subscriber can input a request and/or an order for an elective message tag and/or elective message tagging services, with information regarding the order being stored in the database 10H of the computer-implemented subscription processing system 10, and/or the database 20H of the computer-implemented subscription fulfillment system 20, and/or the database 50H of the computer-implemented subscription management system 50. The computer-implemented subscription processing system 10, and/or the computer-implemented subscription fulfillment system 20, and/or the computer-implemented subscription management system 50, can thereafter process the order or order and notify the subscriber via the communication device 30 and/or the point-of-sale transaction device 40 if and when the ordered and/or requested elective message tag and/or elective message service is available. The individual subscriber may be notified via any appropriate and/or available digital, electronic, and/or physical, and or other communications means, method and/or technique.

In any and/or all of the embodiments described herein, any of the computer-implemented subscription processing system(s) 10, the computer-implemented subscription fulfillment system(s) 20, the computer-implemented subscription management system(s) 50, the communication device(s) 30, and/or the point-of-sale transaction device(s) 40, can be programmed for automatic operation, self-activation, and/or programmed operation. The computer-implemented subscription processing system 10, and/or the computer-implemented subscription fulfillment system 20, and/or the computer-implemented subscription management system 50, can be programmed to automatically generate and/or to transmit messages and/or notices to any of the individual subscribers, retailers, goods and/or services providers, etc., regarding elective message tags, elective message tagging subscriptions, subscription management, the availability of elective message tags, offers related to elective message tagging subscriptions, availability of elective message tags and/or goods and/or services which are the associated with an elective message tagging subscription.

In any and/or all of the embodiments described herein, intelligent agents, software agents, and/or mobile agents, and/or computer code, and/or computer applications, and/or applets, and/or scripts, can be utilized so as to act on behalf of any of the parties and/or any of the respective computers and/or devices described herein. Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

The present invention provides an apparatus and method for providing elective message tagging processing and/or elective message tagging fulfillment services, and/or elective message tagging management, and/or elective message tagging related services.

The present invention provides an apparatus and a method wherein all parties benefit. Elective message tag subscribers can obtain the value of information, data, content, offers, promotions, services, etc. associated with elective message tags. Elective message tag providers and affiliated goods and/or services providers can have the benefit and value of access a highly target and interested audience for relevant information, data, content, offers, promotions, services, etc. associated with elective message tags. Elective message tag service providers and affiliated goods and/or services providers can have the benefit and value derived from creating an improved means for more effectively and efficiently connecting parties to one another for the purposes of communication, information, commerce, and public safety.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. A computer-implemented method, comprising: receiving a request to receive, at a device or devices associated with or used by an individual, a set of individuals, a machine, a set of machines, an elective message tag consisting of any one or more of data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, or an embodiment of information, or an embodiment of control functionality; processing information regarding the request with a processing device, wherein the processing device determines whether the subscription is active or not active or determines whether any elective message tag or elective message tags of the one or more of the data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, or an embodiment of information, or an embodiment of control functionality remain to be fulfilled pursuant to the subscription; and transmitting in response to the request, and in conjunction with a second communication, one or more of data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, or an embodiment of information, or an embodiment of control functionality.

2. The computer-implemented method of claim 1, wherein one or more of the request, the second communication, and/or the elective message tag is transmitted on or over the Internet, World Wide Web, Semantic Web, telecommunication networks, computing networks, terrestrial networks, undersea networks, mobile networks, satellite networks, radio networks, digital communication networks, broadband communication networks, internets and/or intranets, mesh networks, closed circuit networks, open networks, optical networks, neural networks, and/or similarly employable communications and/or computer networks.

3. The computer-implemented method of claim 1, wherein one or more of the request or the second communication or the elective message tag is transmitted on or over or a supra-global network, global network, trans-national network, national network, wide area network, metropolitan area network, local area network, personal area network, inter-being network, intra-being network, human-to-machine network, machine-to-machine network, human-to-non-human network, and/or any other suitable communication network or system.

4. The computer-implemented method of claim 1, further comprising: processing information for establishing subscription agreement to enable one or more of further processing, fulfillment, and managing elective message tagging services.

5. The computer-implemented method of claim 1, further comprising: processing information for one or more of augmenting, increasing, decreasing, supplementing, lengthening, shortening, extending, cancelling, terminating, or otherwise changing the parameters governing the commercial and technical aspects of the subscription agreement.

6. The computer-implemented method of claim 1, further comprising: processing information for creating or initiating the subscription.

7. The computer-implemented method of claim 1, wherein one or more of the request for the elective message tag, the elective message tag, the communication in conjunction with the elective message tag, or data regarding the elective message tag is encrypted.

8. The computer-implemented method of claim 1, wherein the device or devices associated with or being used by the elective message tag subscriber contains decryption software or codes.

9. The computer-implemented method of claim 1, comprising: transmitting the elective message tag or data or information regarding the elective message tag via a communications network, or a computing network directly to the elective message tag subscriber.

10. The computer-implemented method of claim 1, comprising: transmitting the elective message tag or data or information regarding the elective message tag via a communications network, or a computing network to the elective message tag subscriber in conjunction with any one or more of a communications service, commercial service, public welfare service, or computing service provided by a third-party.

11. The computer-implemented method of claim 1, comprising: transmitting the elective message tag or data or information regarding the elective message tag via a communications network, or a computing network to the elective message tag subscriber in conjunction with a client-device used for communications, computing, entertainment, transaction processing, digitally displaying, printing, or for providing video, audio, text, signals, or data.

12. The computer-implemented method of claim 1, comprising: transmitting the elective message tag or data or information regarding the elective message tag via a communications network, or a computing network to the elective message tag subscriber in one or more of an online, virtual, digital, or physical environment.

13. The computer-implemented method of claim 1, wherein the request contains at least one of an access code, an identification code, a personal identification number or code, and information obtained from a computer chip, a microprocessor, a magnetic strip, a biometric scan, an image scan, or from an account card.

14. The computer-implemented method of claim 1, further comprising: processing information for one or more of managing, controlling, monitoring, policy setting, operations management of the elective message tag or the elective message tag subscription or the elective message tagging services.

15. The computer-implemented method of claim 1, further comprising: processing as such executed by intelligent agents or software agents or algorithms or mobile agents or scripts or code on behalf of any of the parties to the elective message tagging services or devices utilized by any of the parties to the elective message tagging services.

16. The computer-implemented method of claim 1, further comprising: processing data or information regarding delivery, technological parameters, or the commercial parameters of the elective message tag or the elective message tag subscription or the elective message tagging services.

17. The computer-implemented method of claim 1, further comprising: storing one or more of elective message tags, or data, information, hyper-links, programs, applications, code, scripts, files, video, audio, images, avatars, pixel tags, clear gifs, web beacons, voice, text, signals, warnings, prompts, requests, advertisements, offers, solicitations, promotions, confirmations, tickets, receipts, content, digital content associated with or comprising elective message tags.

18. The computer-implemented method of claim 1, further comprising: storing communications to which the elective message tag may be affixed or combined.

19. The computer-implemented method of claim 1, further comprising: storing functional commands or instructions or for control of the elective message tag or elective message tag subscription or elective message tag service.

20. The computer-implemented method of claim 1, further comprising: storing functional commands or instructions or data for management of the elective message tag or elective message tag subscription or elective message tag service.

21. The computer-implemented method of claim 1, further comprising: storing data or information regarding a device or devices associated with or used by an individual or by a set of individuals or by a machine or by a set of machines to transmit or receive elective message tags or regarding elective message tag subscriptions or elective message tag services.

22. The computer-implemented method of claim 1, further comprising: storing account information of one or more of a commercial, communications, financial, contextual, informational, historical, transactional, analytical, or technical nature of one or more of the elective message tag subscriber, the elective message tag provider, or the elective message tag service provider, in order to facilitate the processing or fulfillment or management of the elective message tag services.

23. The computer-implemented method of claim 1, wherein the subscription is flexible allowing for augmenting subscription parameters related to one or more of a commercial, communications, financial, contextual, informational, historical, transactional, analytical, or technical nature.

24. The computer-implemented method of claim 1, wherein the subscription is flexible allowing for one or more of manually, dynamically, or automatically augmenting subscription parameters related to one or more of a commercial, communications, financial, contextual, informational, historical, transactional, analytical, or technical nature.

25. The computer-implemented method of claim 1, wherein the subscription is for one or more of a specified number of elective message tags or for a specified time period or for a specified value or for a specified event or for a specified activity or for a specified transaction, and further wherein one or more of the elective message tags can be skipped or foregone in or during the specified time period while allowing a subscriber to be able to maintain or control the quantity or frequency or terms of the remaining elective message tags.

26. The computer-implemented method of claim 1, wherein the request for a subscription contains one or more of an access code, a password, a personal identification number, personally identifying code, a personally identifying metric, a biometric, an account identifying code, an account identifying metric, code, an Internet Protocol address, a device identifying code, a device identifying metric, email address, uniform resource locator, telephone number, mobile telephone number, vector, coordinates, digital contact address, digital contact information, digital place of receipt, unique identifying information, avatar identification, representative identification, third-party identification related to subscription, third-party identification related to subscriber, agent identification, postal contact, and information obtained from a magnetic strip of an account card or from a microprocessor of an account card or from a subscriber identity module card or an electronic account previously associated with the subscriber.

27. The computer-implemented method of claim 1, further comprising: processing search related information regarding one or more of desired or suitable elective message tag, elective message tag services, elective message tag associated services and/or goods, and/or one or more of offers of a commercial, communications, financial, contextual, informational, historical, transactional, analytical, or technical nature.

28. The computer-implemented method of claim 1, further comprising: processing the pairing of offers and requests or requests for elective message tags, or elective message tag services as a result of a search as made by any of the prospective parties to the elective message tagging services, wherein the pairing may be one or more of automated or specifically requested in conjunction with the search activity.

29. The computer-implemented method of claim 1, further comprising: processing bidding information for parties to the elective message tags, or elective message tag services, or affiliated services, allowing for making provisional offers based upon parameters set by an offering party which can be accepted, or to which a counter offers may be made, and if parties should reach an agreement; processing a transaction based upon a completed agreement resulting from the bidding process.

30. The computer-implemented method of claim 1, further comprising: processing payment information for settlement of one or more of accepted offers for receiving elective message tags, elective message tag services, or elective message tag affiliated services and/or goods.

31. The computer-implemented method of claim 1, further comprising: determining that the subscription and/or registration is not active; and processing information for re-opening or renewing the subscription.

32. The computer-implemented method of claim 1, further comprising: generating a notification in response to the subscription and/or registration request of one or more of a registration notification, a rejection notification, a query for additional information, and/or information regarding the availability of one or more of elective message tags, elective message tag services, or elective message tag affiliated services and/or goods.

33. The computer-implemented method of claim 1, further comprising: generating a notification in response to a processing action.

34. The computer-implemented method of claim 1, further comprising a: processing one or more of a request to register, subscribe, communicate, combine and/or attach an elective message tag to a communication, search, pair bids and acceptances, purchase, sell, offer to purchase, offer to sell; processor for processing one or more of a transaction or communication; transmitting a notification of one or more of the processing action, processing activity, communication, or transaction.

35. The computer-implemented method of claim 1, wherein the processor whether the party accessing the processor is authorized, authenticated, whether to accept, reject, further qualify, and/or to facilitate an elective message tagging related service.

36. The computer-implemented method of claim 1, further comprising: generating a second communication, wherein the second communication contains information regarding at least one of an availability of a subscription, an elective message tag, a promotion regarding an elective message tag, or an elective message tagging service; and transmitting the second communication to a communications device or point-of-sale device associated with or utilize by the subscriber, wherein if the second communication is transmitted to the communication device or point-of-sale device utilized in conjunction with one or more of the Internet, the World Wide Web, a wireless communication network, or a terrestrial communication network.

37. The computer-implemented method of claim 1, further comprising: receiving a second request to receive, transact, communicate, or execute one or more of an elective message tag, an elective message tagging service, an elective message tagging management or control function, or an of elective message tagging associated service and/or good; and processing information regarding the second request; determining whether the second subscription is active or not active or determining whether any elective message tagging related services or goods remain to be fulfilled pursuant to the second request; and transmitting a second communication in response to the second request, wherein the second communication contains information regarding any one or more of an authorization, authentication, denial, of the second request, and further wherein the second communication is transmitted to a communication device and/or a point-of-sale device being utilized by the subscriber or party to the elective message tagging services.

38. The computer-implemented method of claim 1, further comprising: receiving a second request to receive an elective message tag related good and/or service, or tickets, or coupon, or postage, or commercial item, pursuant to the elective message tag subscription; and processing information regarding the second request; determining whether the second subscription is active or not active or determining whether any elective message tagging related services or goods remain to be fulfilled pursuant to the second request; and transmitting a second communication in response to the second request, wherein the second communication contains information regarding any one or more of an authorization, authentication, denial, of the second request, and further wherein the second communication is transmitted to a communication device and/or a point-of-sale device being utilized by the subscriber or party to the elective message tagging services.

39. The computer-implemented method of claim 38, wherein the second request is a request for one or more of a ticket or tickets to an entertainment event, entertainment venue, sporting event, commercial event, commercial venue, educational event, education venue, or multiple events or venues.

40. The computer-implemented method of claim 38, further comprising: processing information regarding a changing of the parameters for one or more of the transmission or consumption of the elective message tag, elective message tagging services, or elective message tagging associated services and/or goods.

41. The computer-implemented method, comprising: processing a request to create or initiate a subscription which allows for one or more of elective message tags, elective message tagging services, elective message tagging associated services and/or goods, to be received at a communications device or point-of-sale device associated with a subscriber, wherein the request is transmitted from one or more of a communications device, a transaction device, or from a point-of-sale device associated with or being used by the subscriber, or a provider of services and/or goods to the subscriber, wherein the request contains information regarding an elective message tagging related service, wherein one or more of the elective message tags, elective message tagging services, or elective messaging tagging associated services and/or goods can be skipped or foregone in or during the specified time period while ensuring that a subscriber is able to continue with the subscription or receive all of the specified number of elective message tags, or related elective message tag services, or elective message tag associated services and/or goods at the initially intended or alternative communications device, transaction device, or point-of-sale device, wherein the request is processed by a processing device; creating or initiating a subscription in response to the request; and transmitting a notification to the communications device, or the transaction device, or the point-of-sale device associated with or being used by the subscriber, or a provider of services and/or goods to the subscriber, wherein the message contains information regarding the subscription which was created or initiated.

42. The computer-implemented method of claim 41, wherein at least one of the request and the elective message tag, or elective message tag services, or elective message tag associate services and/or goods is transmitted to the communication device or point-of-sale device utilized in conjunction with one or more of the Internet, the World Wide Web, a wireless communication network, or a terrestrial communication network.

43. The computer-implemented method of claim 41, further comprising: processing information for one or more of renewing, extending, cancelling, or termination the subscription.

44. The computer-implemented method of claim 41, further comprising: processing information for one or more of a search for the subscription, an elective message tag, an elective message tag service, an elective message tag associated service and/or good.

45. The computer-implemented method of claim 41, further comprising: generating a second communication in response to the request to initiate or create a subscription for one or more of an elective message tag, an elective message tag service, an elective message tag associated service and/or good; and transmitting the second communication to one or more of a communication device, transaction device, or point-of-sale device associated with or used by or in service of the subscriber.

46. The computer-implemented method of claim 45, wherein one or more of the request, the second communication, and/or the elective message tag is transmitted on or over the Internet, World Wide Web, Semantic Web, telecommunication networks, computing networks, terrestrial networks, undersea networks, mobile networks, satellite networks, radio networks, digital communication networks, broadband communication networks, internets and/or intranets, mesh networks, closed circuit networks, open networks, optical networks, neural networks, and/or similarly employable communications and/or computer networks.

47. A computer-implemented method comprising: inputting or entering information regarding a request to receive a subscription for one or more of an elective message tag, an elective message tag service, an elective message tag associated service and/or good; transmitting the information regarding the request; receiving the request, wherein the processing device receives the request; processing the request to receive one or more of elective message tags, elective message tagging services, elective message tagging associated services and/or goods; wherein the processor determines whether the request is one or more of affiliated with a subscription, whether the subscription is active, whether the requestor is authorized, whether the requestor is authenticated, or whether there remain any unfulfilled elective message tags, elective message tag related services, or elective message tag associated services and/or goods to be transmitted; transmitting a notification to a communications device or point-of-sale device associated with or being utilized by or in the service of the subscriber, wherein the notification can be one or more of an approval, authorization, denial, offer for renewal; providing and/or displaying the transmitted notification.

48. A computer-implemented method comprising: receiving a request to one or more of initiate a subscription, or receive one or more of an elective message tag, an elective message tag service, an elective message tag associated service and/or good; transmitting the information regarding the request; receiving the request, wherein the processing device receives the request; processing the request to receive one or more of elective message tags, elective message tagging services, elective message tagging associated services and/or goods; wherein the processor determines whether the request is one or more of affiliated with a subscription, whether the subscription is active, whether the requestor is authorized, whether the requestor is authenticated, or whether there remain any unfulfilled elective message tags, elective message tag related services, or elective message tag associated services and/or goods to be transmitted; transmitting a second communication, wherein the second communication may contain or be connected to an elective message tag, an elective message tag service, or an elective message tag associated service and/or good; providing and/or displaying one or more of the transmitted notification or the second message.

49. A computer-implemented method comprising: processing a request to establish or create a subscription for receiving one or more of elective message tags, elective message tagging services, elective message tagging associated services and/or goods; wherein the processor determines whether the request is compliant; establishing or creating a subscription; transmitting a second communication, wherein the second communication may contain or be connected to an elective message tag, an elective message tag service, or an elective message tag associated service and/or good, wherein the second communication is transmitted to and received by one or more of a communications device, a transaction device, or a point-of-sale device associated with or being used by or in the service of the subscriber or a provider of services and/or goods to a subscriber; providing and/or displaying one or more of the transmitted notification or the second message.

50. A computer-implemented method comprising: processing a request to one or more of establish a subscription, or receive one or more of elective message tags, elective message tagging services, elective message tagging associated services and/or goods; wherein the processor determines whether the request is one or more of affiliated with a subscription, whether the subscription is active, whether the requestor is authorized, whether the requestor is authenticated, or whether there remain any unfulfilled elective message tags, elective message tag related services, or elective message tag associated services and/or goods to be transmitted; transmitting a second communication, wherein the second communication may contain or be connected to an elective message tag, an elective message tag service, or an elective message tag associated service and/or good, wherein the second communication is transmitted to and received by one or more of a communications device, a transaction device, or a point-of-sale device associated with or being used by or in the service of the subscriber or a provider of services and/or goods to a subscriber; providing and/or displaying one or more of the transmitted notification or the second message.

51. A computer-implemented apparatus, comprising: a receiver, wherein the receiver receives a request to receive, at a device or devices associated with or used by an individual, a set of individuals, a machine, a set of machines, an elective message tag consisting of any one or more of data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, or an embodiment of information, or an embodiment of control functionality; a processor, wherein the processor processes information regarding the request with a processor, wherein the processing device, wherein the a processor, wherein the processing device determines whether the subscription is active or not active or determines whether any elective message tag or elective message tags of the one or more of the data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, or an embodiment of information, or an embodiment of control functionality remain to be fulfilled pursuant to the subscription; and a transmitter, wherein the transmitter transmits in response to the request, and in conjunction with a second communication, one or more of data, information, hyper-links, programs, applications, code, scripts, files, video, audio, images, avatars, pixel tags, clear gifs, web beacons, voice, text, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, messages, notifications, controls, communications, or an embodiment of information, or an embodiment of control functionality.

52. The computer-implemented apparatus, comprising: a processor, wherein the processor processes a request to create or initiate a subscription which allows for one or more of elective message tags, elective message tagging services, elective message tagging associated services and/or goods, to be received at a communications device or point-of-sale device associated with a subscriber, wherein the request is transmitted from one or more of a communications device, a transaction device, or from a point-of-sale device associated with or being used by the subscriber, or a provider of services and/or goods to the subscriber, wherein the request contains information regarding an elective message tagging related service, wherein one or more of the elective message tags, elective message tagging services, or elective messaging tagging associated services and/or goods can be skipped or foregone in or during the specified time period while ensuring that a subscriber is able to continue with the subscription or receive all of the specified number of elective message tags, or related elective message tag services, or elective message tag associated services and/or goods at the initially intended or alternative communications device, transaction device, or point-of-sale device, wherein the request is processed by a processor, wherein the processor processes device; creating or initiating a subscription in response to the request; and a transmitter, wherein the transmitter transmits a notification to the communications device, or the transaction device, or the point-of-sale device associated with or being used by the subscriber, or a provider of services and/or goods to the subscriber, wherein the message contains information regarding the subscription which was created or initiated.

53. A computer-implemented apparatus comprising: inputting or entering information regarding a request to receive a subscription for one or more of an elective message tag, an elective message tag service, an elective message tag associated service and/or good; a transmitter, wherein the transmitter transmits the information regarding the request; a receiver, wherein the receiver receives the request, wherein the a processor, wherein the processing device receives the request; a processor, wherein the processor processes the request to receive one or more of elective message tags, elective message tagging services, elective message tagging associated services and/or goods; wherein the processor determines whether the request is one or more of affiliated with a subscription, whether the subscription is active, whether the requestor is authorized, whether the requestor is authenticated, or whether there remain any unfulfilled elective message tags, elective message tag related services, or elective message tag associated services and/or goods to be transmitted; a transmitter, wherein the transmitter transmits a notification to a communications device or point-of-sale device associated with or being utilized by or in the service of the subscriber, wherein the notification can be one or more of an approval, authorization, denial, offer for renewal; providing and/or displaying the transmitted notification.

54. A computer-implemented apparatus comprising: a receiver, wherein the receiver receives a request to one or more of initiate a subscription, or receive one or more of an elective message tag, an elective message tag service, an elective message tag associated service and/or good; a transmitter, wherein the transmitter transmits the information regarding the request; a receiver, wherein the receiver receives the request, wherein the a processor, wherein the processing device receives the request; a processor, wherein the processor processes the request to receive one or more of elective message tags, elective message tagging services, elective message tagging associated services and/or goods; wherein the processor determines whether the request is one or more of affiliated with a subscription, whether the subscription is active, whether the requestor is authorized, whether the requestor is authenticated, or whether there remain any unfulfilled elective message tags, elective message tag related services, or elective message tag associated services and/or goods to be transmitted; a transmitter, wherein the transmitter transmits a second communication, wherein the second communication may contain or be connected to an elective message tag, an elective message tag service, or an elective message tag associated service and/or good; providing and/or displaying one or more of the transmitted notification or the second message.

55. A computer-implemented apparatus comprising: a processor, wherein the processor processes a request to establish or create a subscription for a receiver, wherein the receiver receives one or more of elective message tags, elective message tagging services, elective message tagging associated services and/or goods; wherein the processor determines whether the request is compliant; establishing or creating a subscription; a transmitter, wherein the transmitter transmits a second communication, wherein the second communication may contain or be connected to an elective message tag, an elective message tag service, or an elective message tag associated service and/or good, wherein the second communication is transmitted to and received by one or more of a communications device, a transaction device, or a point-of-sale device associated with or being used by or in the service of the subscriber or a provider of services and/or goods to a subscriber; providing and/or displaying one or more of the transmitted notification or the second message.

56. A computer-implemented apparatus comprising: a processor, wherein the processor processes a request to one or more of establish a subscription, or receive one or more of elective message tags, elective message tagging services, elective message tagging associated services and/or goods; wherein the processor determines whether the request is one or more of affiliated with a subscription, whether the subscription is active, whether the requestor is authorized, whether the requestor is authenticated, or whether there remain any unfulfilled elective message tags, elective message tag related services, or elective message tag associated services and/or goods to be transmitted; a transmitter, wherein the transmitter transmits a second communication, wherein the second communication may contain or be connected to an elective message tag, an elective message tag service, or an elective message tag associated service and/or good, wherein the second communication is transmitted to and received by one or more of a communications device, a transaction device, or a point-of-sale device associated with or being used by or in the service of the subscriber or a provider of services and/or goods to a subscriber; providing and/or displaying one or more of the transmitted notification or the second message.
